(19) United States
(12) Patent Application Publication
(10) Pub. No.: US 2013/0330532 A1
(43) Pub. Date: Dec. 12, 2013

(54) DISPERSANT CONTAINING GYPSUM SLURRY

(71) Applicants: Frank Dierschke, Oppenheim (DE); Klaus Prosiegel, Trostberg (DE); Michael Schinabeck, Altenmarkt (DE)

(72) Inventors: Frank Dierschke, Oppenheim (DE); Klaus Prosiegel, Trostberg (DE); Michael Schinabeck, Altenmarkt (DE)

(73) Assignee: BASF Construction Polymers GmbH, Trostberg (DE)

(21) Appl. No.: 13/821,503

(22) PCT Filed: Oct. 7, 2011
(86) PCT No.: PCT/EP2011/067523

§ 371 Date: Aug. 23, 2013

Related U.S. Application Data
(60) Provisional application No. 61/391,796, filed on Oct. 11, 2010.

(51) Int. Cl. C04B 16/04

(52) U.S. Cl. CPC C04B 16/04
USPC 428/220; 524/3; 521/181; 523/122; 264/299; 264/42

(57) ABSTRACT

The subject of the present invention is a gypsum containing aqueous slurry containing a phosphate based polycondensate as sole agent with dispersing properties. With a phosphated polycondensate according to the invention as sole dispersing component an improved efficiency was found in comparison with the polycondensates known in the prior art. As additional favorable effect a significantly decreased retardation of the setting and hardening of the various construction compositions and especially of gypsum based slurries compared to other dispersants is to be observed, independently from the dosage of the dispersing component. This effect of the polycondensate component as well as an expedient influence on the pore structure surprisingly can be observed.

The subject of the present invention is a gypsum containing aqueous slurry containing a phosphate based polycondensate as sole agent with dispersing properties.

### BACKGROUND OF THE INVENTION

Conventional dispersants for cementitious and gypsum compositions typically achieve good water reduction, however, they are limited in their ability to retain workability over a long period of time. An alternate method for extended workability retention is the use of retarding admixtures. In this scenario, the benefit of workability retention is often achieved at the expense of setting times and early strength. The usefulness of these dispersants is therefore limited by their inherent limitations in molecular architecture.

Usual dispersants are static in their chemical structure over time in hydraulic systems. Their performance is controlled by monomer molar ratio that is fixed within a polymer molecule. A water reducing effect or dispersing effect is observed upon dispersant adsorption onto the hydraulic particle surface. As dispersant demand increases over time due to abrasion and hydration product formation, which creates more surface area, these conventional dispersants are unable to respond and workability is lost.

Typically, the issue of extended workability is solved by either re-tempering (adding more water) to the hydraulic compositions or by adding more high range water reducer. Addition of water leads to lower strength and thus creates a need for mixes that are “over-designed” in the way of hydraulic binder content.

Various types of organic compounds have been used to advantageously alter certain properties of wet hydraulic binder compositions. One class of components, which can collectively be called “superplastcizers” fluidify or plasticize wet binder compositions to obtain a more fluid mixture. A controlled fluidity is desired, such that the aggregate used in mortars and concretes does not segregate from the binder paste. Alternatively, superplasticizers may allow the cement composition to be prepared using a lower water:binder ratio in order to obtain a composition having a desired consistency which often leads to a hardened composition having a higher compressive strength development after setting.

A good superplasticizer should not only fluidify the wet hydraulic binder composition to which it is added, but also maintain the level of fluidity over a desired period of time. This time should be long enough to keep the wet composition fluid, e.g. In a ready-mix truck while it is on its way to a job site. Another important aspect relates to the period for discharging the truck at the job site and the period needed for the cement composition for being worked in the desired final form. On the other side, the hydraulic mixture cannot remain fluid for a too long time, that means the set must not greatly be retarded, because this will slow down the work on the job and show negative influences on the characteristics of the final hardened products.

Conventional examples of superplasticizers are melamine sulfonate/formaldehyde condensation products, naphthalene sulfonate/formaldehyde condensation products and lignosulfonates, polysaccharides, hydroxycarboxylic acids and their salts and carbohydrates.

In most cases, fluidizing agents are multi-component products with copolymers based on oxyalkylenglykolalkenylethers and unsaturated dicarboxylic add-derivatives as most important species. The European Patent EP 0 736 553 B1 discloses such copolymers comprising at least three sub-units and especially one unsaturated dicarboxylic acid derivative, one oxyalkylenglykolalkenylether and additionally one hydrophobic structural unit, such as ester units. The third structural unit can also be represented by polypropylenoxid- and polypropylenoxid-polyethylenoxid-derivatives, respectively.

The German published application DE 195 43 304 A1 discloses an additive for water containing mixtures for the construction field comprising a) a water-soluble sulfonic acid-, carboxylic- or sulfate group containing cellulose derivative, b) a sulfonic acid- and/or carboxylic acid containing vinyl-(co)-polymer and/or a condensation product based on aminoplast-builders or acryl containing compounds and formaldehyde. This additive shall show sufficient water retention ability and rheology-modifying properties. Therefore, this additive shall be suitable for construction chemical compositions containing cement, lime, gypsum, anhydrite and other hydraulic binder components.

Copolymers based on unsaturated monocarboxylic or dicarboxylic add derivatives, oxyalkylenglykoalkenylethers, vinylic polyalkylenglykol, polysiloxane or ester compounds used as additives for aqueous suspensions based on mineral or bituminous binders are described in U.S. Pat. No. 6,777,517 B1. The use of such additives results in a decrease in the water/binder ratio and leads to highly fluid building materials without segregation of individual constituents from the building material mixture. The copolymers according to this U.S. patent are useful as additives for aqueous suspensions of inorganic and organic solids and especially for suspensions that are based on mineral or bituminous binders such as cement, plaster of paris, lime, anhydrite or other building materials based on calcium sulfate.

Disclosed by prior art also are copolymers of ethylenically unsaturated ethers that can be used as plasticizers for cement containing mixtures (EP 0 537 870 A1). These copolymers contain an ether co-monomer and as additional co-monomer an olefinic unsaturated mono-carboxylic acid or an ester or a salt thereof, or alternatively an olefinic unsaturated sulfuric acid. These copolymers show a very short ether side chain with 1 to 50 units. The short side chain causes a sufficient plasticizing effect of the copolymers in cement containing masses with a reduced slump loss of the construction chemicals mass itself.

U.S. Pat. No. 6,139,623 B1 discloses an emulsion admixture for use in hydraulic cement compositions formed by emulsifying an antifoaming agent, a surfactant and a copolymer having a carbon-containing backbone to which are attached groups that function as cement-anchoring members by forming ionic bonds and oxyalkylene groups. This admixture comprising an ethylene oxide/propylene oxide (EO/PO) type comb polymer and an antifoaming agent allows a predictable air control in hydraulic cement compositions such as concrete. The term “cement composition” refers to pastes, mortars, grouts such as oil well cementing grouts, and concrete compositions comprising a hydraulic cement binder. Typical antifoaming agents are phosphate ester, borate ester and polyoxyalkylene copolymers with defoaming properties. The surface active component (surfactant) is said to stabilize the emulsion mixture and is chosen from the group consisting of an esterified fatty acid ester of a carbohydrate, a C₂ to C₂₀ alcohol having polyoxyalkylene groups or a mixture thereof.

US 2006/0281886 discloses a co-polymer comprising two monomer components with a component a) being an olefinic unsaturated monocarboxylic acid co-monomer or an ester or a salt thereof or an olefinic unsaturated sulfonic acid co-monomer or a salt thereof, and with component b) preferably represented by an ether compound. These two monomeric co-polymer can be preferably used as a superplasticizer in a hydraulic binder containing composition. There it is alternatively disclosed that the co-polymer can be used in combination with a defoaming component that is also an additional structural unit of the co-polymer. Consequently, the defoaming component can be chemically attached to the co-polymer or being present in free form in a blend. Under general aspects the prior art teaches the use of dispersing agents (plasticizers) such as polycarboxylate ethers (PCE) as typical additive for calcium sulfate containing binder systems. This results in a water reduction as well as in an enhancement of physical properties such as compressive strength. Additionally, the workability and preferably the rheological behavior of the construction chemicals composition are improved. On the other hand the addition of PCE based dispersants causes a distinct air entrainment to the binder component that worsens the physical properties of the composition. Another negative aspect is the foam formation during the preparation of the binder system. For overcoming these drawbacks defoamer components are used as additional additive to the dispersing agent. However, defoamers show a low solubility in aqueous formulations and cause an insufficient stability. Moreover, the defoaming properties of the formulation decrease over time due to the resulting phase separation of the defoamer and the dispersant.

Based on the different characteristics and the availability of the superplasticizers mentioned above, it has been further desired to come up with new formulations suitable as admixtures which are an improvement over the current state of the art. It is thus an object of this invention to provide new formulations for calcium sulfate binder containing compositions which impart to wet binder compositions excellent fluidizing and water reduction properties. Furthermore, the properties, the performance and effects of the provided copolymer shall be arbitrary.

In the production of gypsum plasterboard, in order to decrease the drying costs it is necessary to establish as low as possible a water/gypsum value. In addition, the gypsum mixture should set as rapidly as possible, so that the necessary cutting strength of the plate is attained on the conveyor line after as short a time as possible. For these reasons, dispersants based in particular on polycarboxylate ethers were developed (DE 10 2006 027 035 A1; U.S. Pat. No. 7,070,648 B1).

US 2008/017078 teaches a liquid admixture composition for a calcium sulfate based binder system and a method of use. The disclosed admixture comprises an aqueous composition of a copolymeric dispersing component, an antifoaming agent component, a surfactant component and water. The components may be a blend or physically or chemically attached and result in a stable liquid system that can be used as dispersing agent for calcium sulfate compound containing construction chemicals composition. The admixture composition disclosed in this document and especially its application as dispersing agent represent a further improvement of this state of the art because the admixture with its contained aqueous composition induces a uniform plasticizing effect all the time and an improvement of the physical properties due to reduction of both water and air content in the wet construction chemicals gypsum mass. Furthermore, the admixture shows an improved storage stability and homogeneity.

Gypsum mixtures for foaming, solid and fast drying gypsum products and a method of making a gypsum slurry by using modifiers and dispersants are disclosed by US 2009/0101045, US 2006/0281837, US 2006/0280899, US 2006/0280898, US 2006/0278135, US 2006/0278134, US 2006/0278130, US 2006/0278127, US 2005/0250888. US 2005/0239924 and US 2006/0280970. The dispersants mentioned in these documents represent polycarboxylate dispersants, the dispersant having two repeating units with an olefinic unsaturated mono-carboxylic acid repeating unit and a vinyl or allyl-group bound to a polyether by an ether linkage as second repeating unit. The results given in any of these documents confirm that such dispersants can be used to attain advantageous physical properties known from superplasticizers such as polycarboxylate ethers.

This invention also relates to gypsum products. More specifically, it relates to a gypsum-based structural panel that requires less time or less energy for drying than conventional products.

Gypsum-based panels are commonly used in construction. Wallboard made of gypsum is fire retardant and can be used in the construction of walls of almost any shape. It is used primarily as an interior wall or exterior wall or ceiling product. Gypsum has sound-deadening properties. It is relatively easily patched or replaced if it becomes damaged. There are a variety of decorative finishes that can be applied to the wallboard, including paint and wallpaper. Even with all of these advantages, it is still a relatively inexpensive building material.

One reason for the low cost of wallboard panels is that they are manufactured by a process that is fast and efficient. Calcium sulfate hemihydrate hydrates in the presence of water to form a matrix of interlocking calcium sulfate dihydrate crystals, causing it to set and to become firm. A slurry that includes the calcium sulfate hemihydrate and water is prepared in a mixer. When a homogeneous mixture is obtained, the slurry is continuously deposited on a moving surface that optionally includes a facing material. A second facing material is optionally applied thereover before the slurry is smoothed to a constant thickness and shaped into a continuous ribbon. The continuous ribbon thus formed is conveyed on a belt until the calcined gypsum is set, and the ribbon is thereafter cut to form panels of desired length, which panels are conveyed through a drying kiln to remove excess moisture. Since each of these steps takes only minutes, small changes in any of the process steps can lead to gross inefficiencies in the manufacturing process.

The amount of water added to form the slurry is in excess of that needed to complete the hydration reaction. Excess water gives the slurry sufficient fluidity to flow out of the mixer and onto the facing material to be shaped to an appropriate width and thickness. As the product starts to set, the water pools in the interstices between dihydrate crystals. The hydration reaction continues building the crystal matrix around the pools of water, using some of the pooled water to continue the reaction. When the hydration reactions are complete, the unused water occupying the pools leaves the matrix by evaporation. Interstitial voids are left in the gypsum matrix when all water has evaporated. The interstitial voids are larger and more numerous where large amounts of excess water are used.

While the product is wet, it is very heavy to move and relatively fragile. The excess water is removed from the board by evaporation. If the excess water were allowed to evaporate at room temperature, it would take a great deal of space to stack and store wallboard while it was allowed to air dry over a relatively lengthy time period or to have a conveyor long enough to provide adequate drying time. Until the board is set and relatively dry, it is somewhat fragile, so it must be protected from being crushed or damaged.

To hasten evaporation, the wallboard panel is usually dried by evaporating the excess water at elevated temperatures, for example, in an oven or kiln. It is relatively expensive to operate the kiln at elevated temperatures, particularly when the cost of fossil fuels rises. A reduction in production costs could be realized by reducing the amount of excess water present in set gypsum boards that is later removed by evaporation. Another reason to decrease excess water is that the strength of gypsum panels is, in some cases, inversely proportional to the amount of excess water used in its manufacture. Large numbers and size of the interstitial voids decrease the density and strength in the finished panel.

Dispersants are known for use with gypsum that help fluidize the mixture of water and calcium sulfate hemihydrate so that less water is needed to make a flowable slurry. β-Naphthalene sulfonate formaldehyde (“BNS”) and melamine sulfonate formaldehyde (“MFS”) condensate dispersants are well known, but have limited efficacy. The preparation and use of BNS is well known state of the art and disclosed in EP 0 214 412 A1 and DE-PS 2 007 603, herein incorporated by reference. The effect and properties of BNS can be modified by changing the molar ratio between formaldehyde and the naphthalene component that usually is from about 0.7 up to about 3.5. The ratio between formaldehyde and the sulfonated naphthalene component preferably is from about 0.8 to 3.5 to about 1. BNS condensates are added to the hydraulic binder containing composition in amounts from about 0.01 up to about 6.0 wt. %.

Melamine-sulfonate-formaldehyde-condensates are broadly used as flow improving agents in the processing of hydraulic binder containing compositions such as dry mortar mixtures, pourable mortars and other cement bonded construction materials and in the production of gypsum panels. Melamine is used in this connection as representative of s-triazine. They cause a strong liquefying effect of the construction chemicals mixture without any undesired side effects occurring in the processing or in the functional properties of the hardened building material. As it is for the BNS technology, there is also broad prior art for MFS. MFS dispersants are revealed in DE 196 09 614 A1, DE 44 11 797 A1, EP 0 059 353 A1 and DE 195 38 821 A1.

DE 196 09 614 A1 discloses a water soluble polycondensation product based on an amino-s-triazine and its use as plasticizer in aqueous binder containing suspensions based on cement, lime and gypsum. These polycondensates are capable in two condensation steps whereby in a pre-condensation step the amino-s-triazine, the formaldehyde component and the sulfite are condensed at a molar ratio of 1 to 0.5:5.0 to 0.1:1.5. Melamine is a preferred representative of amino-s-triazines. Further suitable representatives are amino plast former selected from the group urea, thiourea, dicyandiamide or guanidine and guanidine salts.

According to DE 44 11 797 A1 sulfanilic acid-containing condensation products based on amino-s-triazines that show at least two amino groups are prepared by using formaldehyde. The sulfanilic acid is used in amounts of from 1.0 to 1.6 mol per mol amino-s-triazine and neutralized in aqueous solution with an alkaline metal hydroxide or in earth alkaline metal hydroxide. In an additional step the formaldehyde is added in amounts of from 3.0 to 4.0 mol per mol amino-s-triazine at a pH value between 5.0 to 7.0 and at temperatures between 50 and 90° C. The final viscosity of the solution is between 10 and 60 cSt at 80° C.

According to EP 0 059 353 A1 highly concentrated and low viscose aqueous solutions of melamine/aldehyde resins are capable by reacting melamine and an aldehyde in an alkaline medium in a first step with a component selected from the group comprising alkali sulphate, earth alkali sulphate or (earth) alkali sulfonate or other suitable amino compounds to a pre-condensate. This mixture in an additional process step is reacted with another amino compound such as amino acids or amino carbonic acids and finally the resin solution is brought to an alkaline pH value.

DE 195 38 821 A1 discloses a condensate based on an amino-s-triazine with at least two amino groups and formaldehyde, and a high content of sulfonic acid groups and a low content of formate. Such products can be prepared according to this document by reacting the amino-s-triazine, formaldehyde and a sulfite at a molar ratio of 1:3.0:6.0:1.51:2.0 in an aqueous solution and at a temperature between 60 and 90° C. and a pH value between 9.0 and 13.0 until the sulfite is no longer present. In an additional step the condensation process is conducted at a pH value between 3.0 and 6.5 and at temperatures between 60 and 80° C. until the condensation product at 80° C. shows a viscosity between 5 and 50 mm²/s. Finally, the condensation product is to be brought to a pH value between 7.5 and 12.0 or treated thermally by a pH≧10.0 and a temperature between 60 and 100° C.

Polycarboxylate dispersants are commonly used with cements and, to a lesser degree, with gypsum. The class of compounds represented by the term “polycarboxylate dispersants” is large, and it is very difficult to predict how individual compounds react in different media. The use of a two-monomer polycarboxylate dispersant in gypsum products is disclosed in U.S. Ser. No. 11/152,418, herein incorporated by reference.

As has been previously disclosed, many polycarboxylate dispersants have deleterious effects on gypsum-based products. These dispersants retard setting of the calcined gypsum. The degree of retardation depends on the exact formulation of the polycarboxylate dispersant. Some polycarboxylate dispersants also cause a loss in compressive strength due to stabilization of foam. This leads to formation of smaller voids within the set gypsum. It is difficult to predict how severely a polycarboxylate dispersant will react in a gypsum slurry merely from the chemical formula.

A relatively new class of dispersants has become known for use in cements. It is a phosphated polycondensate dispersant. Although this dispersant is very effective for use in cement, it has low efficacy in gypsum slurries, but it is also low in set retardation.

WO 20061042709 describes polycondensates based on an aromatic or heteroaromatic compound (A) having 5 to 10 C atoms or heteroatoms, having at least one oxyethylene or oxypropylene radical, and an aldehyde (C) selected from the group consisting of formaldehyde, glyoxylic acid and benzaldehyde or mixtures thereof, which result in an improved plasticizing effect of inorganic binder suspensions compared with the conventionally used polycondensates and maintain this effect over a longer period (“slump retention”). In a particular embodiment, these may also be phosphated polycondensates. The phosphated monomers used are, however, relatively expensive since they have to be separately prepared and purified.

Alternatively, there has been developed an economical dispersant, based on a phosphated polycondensate, for hydraulic binders, which dispersant is particularly suitable as a plasticizer/water-reducing agent for concrete and can be prepared in a simple manner and at low cost it is described in provisional application EP 081659155.3, filed in August 2008.

Those who install gypsum panels become fatigued by continuously moving and lifting the panels. It is, therefore advantageous to make panels that are lightweight for ease in handling. Lightweight panels can be made by adding foam to the gypsum slurry. A foaming agent, such as soap, can be added to the slurry so that foam is produced by the mixing action. In some cases, the foaming agent is used to pregenerate a foam that is added to the slurry after it exits the mixer. The foaming agent is selected to produce a foam that is actively coalescing while hydration is taking place. A distribution of foam bubble sizes results from an “active” foam. As the hydration reactions proceed, the gypsum matrix builds up around the foam bubbles, leaving foam voids in the matrix when the set gypsum forms and the foam bubbles break.

It can be difficult to obtain a distribution of foam voids that results in an acceptable reduction in panel strength. Foam voids that are very small and numerous have very thin walls of gypsum matrix between them. Poor compressive strength of the finished panel may result. Formation of very large foam voids can produce unevenness in the surface of the panel, making it aesthetically unacceptable. It has been found that when the set gypsum has a distribution of large and small foam voids, the panel can have both strength and an aesthetically pleasing appearance. This foam void distribution can be achieved by using a combination of soaps that form stable foam and soaps that form unstable foam.

It is clear that design of a gypsum panel includes many variables that are interrelated. Dispersants used to reduce water also change the set time of the gypsum slurry. Some dispersants stabilize foam bubbles, while other dispersants destabilize the foam. Set accelerators that increase the hydration speed also reduce fluidity of the slurry. In addition to changing bubble size distribution, soaps restrict slurry fluidity. The additives used to control the slurry fluidity, hydration speed and foam bubble size distribution each affect multiple variables, making it difficult to strike a balance among all of these factors.

In this relation it is referred to the published patent applications WO 2010/04612 and WO 2010/04611, both of Construction Research & Technology GmbH, the pending and not published patent application PCT/EP2010/062168 of BASF Construction Polymers GmbH and the pending and not published patent application U.S. Ser. No. 61/239,259 of United Gypsum Company. The disclosures of these applications are incorporated by reference to this application.

It was therefore the object of the present invention to provide an economical and effective new gypsum slurry based on a suitable and well established dispersing component for anorganic binders, which dispersant is particularly suitable as a plasticizer/water reducing agent for concrete and other hydraulic binder based systems and that can be prepared in a simple manner and at low costs.

Provided by this invention therefore is a one dispersant formulation for extending workability to an anorganic binder and preferably a calcium sulfate containing mixture and water, comprising introducing into the gypsum slurry one defined dispersing component. The subject dispersant achieves a better workability and fluidibility of anorganic setting compositions and establishes a low water/hydraulic binder value.

### DETAILED DESCRIPTION

The present invention relates to a Gypsum-Slurry containing a compound with dispersing properties, characterized in that the slurry contains as dispersant a polycondensation product containing
(I) at least one structural unit with an aromatic or heteroaromatic sub-unit and a polyether side chain and
(II) at least one phosphated structural unit with an aromatic or heteroaromatic sub-unit,
and preferably additionally
(III) at least one structural unit with an aromatic or heteroaromatic sub-unit,
   structural unit (II) and structural unit (III) differing exclusively in that the OP(OH)₂ group of the structural unit (II) is replaced by H in structural unit (III), and structural unit (III) is not the same as structural unit (I).

The main aspect in connection with novelty and inventive step of this invention is to be seen in that the gypsum slurry contains the polycondensation product as the sole compound with dispersing properties. That means that the polycondensation product containing
(I) at least one structural unit with an aromatic or heteroaromatic sub-unit and a polyether side chain and
(II) at least one phosphated structural unit with an aromatic or heteroaromatic sub-unit,
and preferably additionally
(III) at least one structural unit with an aromatic or heteroaromatic sub-unit, structural unit (II) and structural unit (III) differing exclusively in that the OP(OH)₂ group of the structural unit (II) is replaced by H in structural unit (III), and structural unit (III) is not the same as structural unit (I),
   shows excellent effects in and on the gypsum slurry without being combined with other dispersants such as, but not limited to compounds at least containing a branched comb polymer having polyether side chains, a naphthalene sulphonate-formaldehyde condensate (“BNS”) and a melamine sulphonate-formaldehyde condensate (“MSF”),

The term “hydraulic binder” according to this invention means cement and preferably Portland cement represented by CEM I, CEM II, CEM III, CEM IV and CEM V, white cement, quick lime and aluminate cement.

The term “latent hydraulic binder” according to this invention means at least one representative selected from the group fly ash, blast furnace slag, metakaoline, microsilica, trass compounds, alumosilicates, tuff, phomulithe, diatomaceous earth and oil shell.

The term “calcium sulfate compound” according to this invention means calcium sulfate in its anhydrous and hydrate forms, such as gypsum, anhydrite, calcium sulfate dihydrate and calcium sulfate hemi-hydrate.

The term “gypsum” according to this invention is also known as calcium sulfate, whereby calcium sulfate can be used in its various anhydrous and hydrate forms with or without crystal water. Natural gypsum is represented by calcium sulfate dihydrate and the natural crystal water free form of calcium sulfate is represented by the term “anhydrite”. Besides the natural forms, calcium sulfate is a typical by-product of technical processes characterized by the term “synthetic gypsum”. One example of such technical processes is the flue gas desulphurization. Synthetic gypsum may also be a by-product of phosphorous acid and hydrogen fluoride production methods for gaining hemi-hydrate forms (CaSO₄ ½H₂O). Gypsum (CaSO₄.2H₂O) may be calcinated by driving off the water of hydration. Products of the various calcinating procedures are alpha or beta hemi-hydrate. Beta calcium sulfate hemi-hydrate results from a rapid heating in open units by a rapid evaporation of water and by forming cavities. Alpha hemi-hydrate is produced by a de-watering of gypsum in closed autoclaves. The crystal form in this case is dense and therefore, this binder needs less amounts of water than beta hemi-hydrate. On the other hand, gypsum hemi-hydrate re-hydrates with water to dihydrate crystals. Usually, the hydration of gypsum needs some minutes to hours indicating a clearly shortened workability period in contrast to cements that hydrate in periods over hours or days. These characteristics make gypsum an attractive alternative to cement as hydraulic binder in various fields of application, because hardened final gypsum products show a characteristic hardness and compressive strength.

Calcium sulfate hemi-hydrate can produce at least two crystal forms, whereby α-calcined gypsum is usually de-watered (de-hydrated) in closed autoclaves. For various fields of application, β-calcined gypsum may be selected due to its availability under economical aspects. However, these advantages may be reversed because β-calcined gypsum needs higher water amounts for workability and for making slurries of a given fluidity. Hardened or dried gypsum tends to a certain weakening based on the remained water in its crystal matrix. Therefore, products thereof show less strength than gypsum products that have been made with smaller amounts of water.

In general, the workability of gypsum, but also of other hydraulic binders, can be improved under hydraulic aspects by adding dispersants. In this connection, the formulation according to this invention represents a suitable dispersant because of the dispersing properties of its component.

### 1. Component a)

Component a) of the formulation according to the invention has dispersing properties and is selected from the group consisting of a compound at least containing a branched comb polymer having polyether side chains, a naphthalene sulphonate-formaldehyde condensate (“BNS”), and a melamine sulphonate-formaldehyde condensate (“MSF”),

Formulations which contain a branched comb polymer having polyether side chains as the component a) with dispersant action have been found extremely effective. It therefore can be seen as preferred embodiment that the component a) is a polycarboxylate ether a₁), a polycarboxylate ester a₂), an uncharged copolymer a₃) or a mixture thereof. In general and additionally to the dispersing properties of component a) polycarboxylate ester a₂) are preferred that show anti-foaming and surface active activities.

1.1 Copolymer a₁:

Such polyether-containing copolymers, which in the sense of the present invention are suitable as component a₁), have been previously described in WO 2006/133933 A2. These copolymers consist of two monomer components, the first monomer component being an olefinically unsaturated monocarboxylic acid comonomer or an ester or a salt thereof and/or an olefinically unsaturated sulphonic acid comonomer or a salt thereof, and the second monomer component a comonomer of the general formula (I)

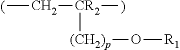

wherein R₁ represents

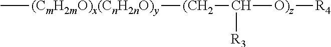

and R₂ represents H or an aliphatic hydrocarbon residue with 1 to 5 C atoms; R₃=unsubstituted or substituted aryl residue and preferably phenyl, and R₄=H or an aliphatic hydrocarbon residue with 1 to 20 C atoms, cycloaliphatic hydrocarbon residue with 5 to 8 C atoms, a substituted aryl residue with 6 to 14 C atoms or a member of the series

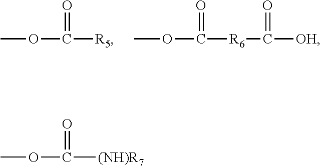

wherein R₅ and R₇ each represent an alkyl, aryl, aralkyl, or alkaryl residue and R₆ for an alkylidene, arylidene, aralkylidene or alkarylidene residue, and
p=0, 1, 2, 3 or 4
m, n mutually independently mean 2, 3, 4 or 5
x and y mutually independently denote an integer ≦350
and
z=0 to 200.

In this connection (I) in copolymer a₁) the comonomer units which represent the components 1) and 2) have in each case no internal molecular differences and/or (II) the copolymer a₁) represents a polymeric mixture of the components 1) and 2), in which case the comonomer units have internal molecular differences with respect to the radicals R₁ and/or R₂ and/or R₃ and/or R₄ and/or R₅ and/or R₆ and/or R₇ and/or m and/or n and/or x and/or y and/or z, and the differences discussed relate in particular to the composition and length of the side chains.

With regard to the copolymer the disclosure of WO 2006/133933 A2 is a substantial integral of the present disclosure.

In particular, the present invention comprises a formulation wherein the copolymer a₁) contains the comonomer component 1) in proportions of 30 to 99 mol. % and the comonomer component 2) in proportions of 70 to 1 mol. %. A copolymer a₁) which contains the comonomer component 1) in proportions of 40 to 90 mol. % and the comonomer component 2) in proportions of 60 to 10 mol. % has been found particularly advantageous in this connection.

The comonomer component 1) can preferably be an acrylic acid or a salt thereof and the comonomer component 2) in the case where p=0 or 1 a modification which contains a vinyl or allyl group and as the residue R₁ₐ polyether.

Further, in the context of the present invention, it can be regarded as advantageous if the comonomer component 1) derives from the group acrylic acid, methacrylic acid, crotonic acid, isocrotonic acid, allylsulphonic acid, vinylsulphonic acid and suitable salts thereof and alkyl or hydroxyalkyl esters thereof.

In addition, the copolymer a) can have additional structural groups in copolymerized form, which is also taken into account by the present invention. In this case, the additional structural groups may be styrenes, acrylamides and/or hydrophobic compounds, ester structural units, polypropylene oxide and polypropylene oxide/polyethylene oxide units being particularly preferred. The copolymer a) should contain the said additional structural groups in proportions up to 5 mol. %, preferably from 0.05 to 3.0 mol. % and in particular from 0.1 to 1.0 mol. %.

In addition, it is advantageous if the formula (I) stands for a polyether containing allyl or vinyl groups.

With regard to the carboxylate ester modifications a₂) and the possible forms thereof, reference is in particular made to EP 0 753 488 B1, the content thereof with regard to the dispersants described in that document being an integral part of the present disclosure.

Concerning the polycarboxylate ester a₂) as preferred comb polymer, the present invention specifies that this ester a₂) is a polymer which can be prepared by polymerization of a monomer mixture (I) containing, as the main component, a representative of the carboxylic acid monomer type. An important aspect of component a₂) according to the present invention has to be seen in the anti-foaming and/or defoaming and/or surface active properties of such polycarboxylate ester types. This is why the formulation according to the present invention also comprises a combination of an antifoaming/surface active agent with dispersing properties as component a) and the polycondensate component b). In a more preferred embodiment the monomer mixture (I) contains an (alkoxy)polyalkylene glycol mono(meth)acrylate monomer (a) of the general formula (II)

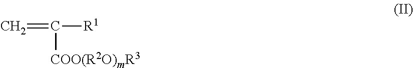

in which R¹ represents a hydrogen atom or a CH₃ group, R²O represents one representative or a mixture of at least two oxyalkylene groups having 2 to 4 carbon atoms, R³ represents a hydrogen atom or an alkyl group having 1 to 5 carbon atoms and m represents a number between 1 and 250 and represents the average number of moles of the oxyalkylene group added,
additionally, as monomer (b), a (meth)acrylic acid of the general formula (III),

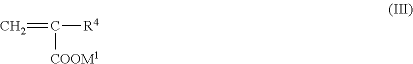

in which R⁴ represents a hydrogen atom or a CH₃ group and M¹ represents a hydrogen atom, a monovalent metal atom, a divalent metal atom, an ammonium group or an organic amine group, and optionally a monomer (c) which is copolymerized with the monomers (a) and (b). The monomer (a) can be present in an amount of from 5 to 98 wt. %, the monomer (b) in a proportion of from 2 to 95 wt. % and the monomer (c) In a proportion up to 50 wt. % in the monomer mixture (I), wherein the respective proportions of the monomers (a), (b) and (c) add up to 100 wt. %.

As typical representatives of the monomer (a), hydroxyethyl(meth)acrylate, hydroxypropyl(meth)acrylate, polyethylene glycol mono(meth)acrylate, polypropylene glycol mono(meth)acrylate, polybutylene glycol mono(meth)acrylate, polyethylene glycol polypropylene glycol mono(meth)acrylate, polyethylene glycol polybutylene glycol mono(meth)acrylate, polypropylene glycol polybutylene glycol mono(meth)acrylate, polyethylene glycol polypropylene glycol polybutylene glycol mono(meth)acrylate, methoxypolyethylene glycol mono(meth)acrylate, methoxypolypropylene glycol mono(meth)acrylate, methoxypolybutylene glycol mono(meth)acrylate, methoxypolyethylene glycol polypropylene glycol mono(meth)acrylate, methoxypolyethylene glycol polybutylene glycol mono(meth)acrylate, methoxypolypropylene glycol polybutylene glycol mono(meth)acrylate, methoxypolyethylene glycol polypropylene glycol polybutylene glycol mono(meth)acrylate, ethoxypolyethylene glycol mono(meth)acrylate, ethoxypolypropylene glycol mono(meth)acrylate, ethoxypolybutylene glycol mono(meth)acrylate, ethoxypolyethylene glycol polypropylene glycol mono(meth)acrylate, ethoxypolyethylene glycol polybutylene glycol mono(meth)acrylate, ethoxypolypropylene glycol polybutylene glycol mono(meth)acrylate, ethoxypolyethylene glycol polypropylene glycol polybutylene glycol mono(meth)acrylate or mixtures thereof are possible.

For the monomer (b), representatives of the group consisting of acrylic acid, methacrylic acid, monovalent metal salts, divalent metal salts, ammonium salts and organic amine salts thereof and mixtures of at least two of the said representatives are to be regarded as preferred.

As regards the monomer (c), the formulation according to the invention should contain at least one representative of the esters of an aliphatic alcohol with 1 to 20 carbon atoms with an unsaturated carboxylic acid. As the unsaturated carboxylic acid, in particular maleic acid, fumaric acid, citraconic acid (meth)acrylic acid or monovalent metal salts, divalent metal salts, ammonium salts or organic amine salts thereof are especially suitable. Monoesters or diesters of unsaturated dicarboxylic acids such as maleic acid, fumaric acid or citraconic acid with aliphatic C₁-C₂₀ alcohols, C₂-C₄ glycols or with (alkoxy)polyalkylene glycols are preferred representatives of monomer (c) according to the present invention.

1.2 Copolymer a₂:

In the context of the present invention, the component a₂) can be a copolymer which is made up of at least one of the following monomers:

A) an ethylenically unsaturated monomer, containing a hydrolysable residue
B) an ethylenically unsaturated monomer with at least one C₂-C₄ oxyalkylene side group with a chain length from 1 to 30 units;
C) an ethylenically unsaturated monomer with at least one C₂-C₄ oxyalkylene side group with a chain length from 31 to 350 units.

In a preferred embodiment of the present invention components B) and C) are simultaneously represented in the copolymer a₂) of the claimed formulation.

In this copolymer modification, built up of at least one of the monomers A), B) and C), according to the invention the ethylenically unsaturated monomer of the component A) can be at least one anhydride or imide and/or at least one maleic anhydride or maleimide. The ethylenically unsaturated monomer of the component A) can however also include an acrylate ester with an ester functionality which contains the hydrolysable residue. In this case, it should be regarded as preferred if the ester functionality is at least one hydroxypropyl or hydroxyethyl radical.

In a further embodiment the copolymer a₂) can however comprise more than one ethylenically unsaturated monomer with a hydrolysable radical. Here it is in particular recommended that the ethylenically unsaturated monomer of the component A) as a residue has at least more than one representative of the ethylenically unsaturated monomers, at least one representative of a hydrolysable radical or a mixture of both. In this connection, the hydrolysable radical should have at least one C₂-C₂₀ alcohol functionality. The present invention also includes the possibility that the hydrolysable residue is at least one C₁-C₂₀ alkyl ester, one C₁-C₂₀ aminoalkyl ester, one C₂-C₂₀ alcohol, one C₂-C₂₀ amino alcohol or one amide.

The present invention further comprises that at least one ethylenically unsaturated monomer of the component B) or C) has a C₂-C₈ alkyl ether group. In this case, the ethylenically unsaturated monomer can have a vinyl, allyl or (methyl)allyl ether residue or else be derived from an unsaturated C₂-C₈ alcohol. In the last-named case of the unsaturated C₂-C₈ alcohol, at least vinyl alcohol, (meth)allyl alcohol, isoprenol or methylbutenol are especially preferred possibilities as representatives.

The ethylenically unsaturated monomer side groups of the component B) or C) can however also contain at least one C₄ oxyalkylene unit.

Overall, in connection with the modifications just described, concerning the comb polymer a₂) it can be stated that at least one ethylenically unsaturated monomer of the components B) or C) can have a C₂-C₈ carboxylate ester, which in particular is hydrolysable. Further, the present invention includes a modification wherein the oxyalkyl side groups have at least one ethylene oxide, one propylene oxide, one polyethylene oxide, one polypropylene oxide or mixtures thereof.

Finally, the copolymer a₂) in the component C) can have at least one nonionic (“uncharged”) and/or one non-hydrolysable monomer residue or mixtures thereof.

1.3 Copolymer a₃:

In addition to the two modifications just described in detail with regard to the component a), namely its form as polycarboxylate ethers and polycarboxylate esters, the present invention also includes a third modification of the comb polymer a), which then is a nonionic (uncharged) copolymer a). Here, representatives of the general formula (IV) are preferred,

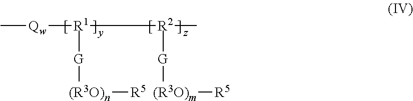

wherein Q stands for an ethylenically unsaturated monomer with at least one hydrolysable residue, G means O, C(O)—O or O—(CH₂)p-O with p=2 to 8, wherein mixtures of the modifications of G in one polymer are possible; R¹ and R² mutually independently mean at least one C₂-C₈ alkyl; R³ comprises (CH₂)ₒ, where c is a whole number between 2 and 5 and where mixtures of the representatives of R³ in the same polymer molecule are possible; R⁵ means at least one representative selected from the series H, a linear or branched, saturated or unsaturated C₁-C₂₀ aliphatic hydrocarbon residue, a C₅-C₈ cycloaliphatic hydrocarbon residue or a substituted or unsubstituted C₆-C₁₄ aryl residue; m=1 to 30, n=31 to 350, w=1 to 40, y=0 to 1 and z=0 to 1, where the sum (y+z)>0.

However, the nonionic copolymer a₃) can alternatively also be a representative of the general formula (V),

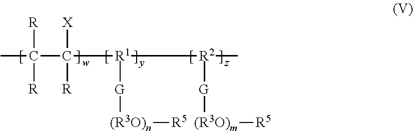

wherein X stands for a hydrolysable residue and R for H or CH₃, and G, p, R¹, R², R³, R⁵, m, n, w, y, z and (y+z) have the meanings stated under the formula (IV).

In the case where the structure of the non-ionic copolymer a₃) corresponds to the formula (V), in a preferred embodiment the hydrolysable residue can be at least one representative of the series alkyl ester, aminoalkyl ester, hydroxyalkyl ester, aminohydroxyalkyl ester or amide.

As a third alternative as regards the nonionic copolymer a₃), the present invention specifies at least one representative of the general formula (VI)

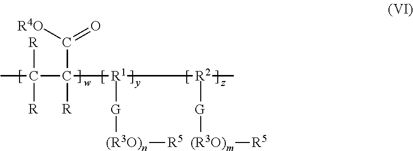

wherein R⁴ means at least one C₁-C₂₀ alkyl or C₂-C₂₀ hydroxyalkyl radical and the radicals G, p, R, R¹, R², R³, c, R⁴, R⁵ and m, n, w, y, z and (y+z) have the meanings stated under the formulae (IV) and (V).

It is to be regarded as preferred option that in this formula (VI), p=4, R⁴=C₂H₄OH or C₃H₆OH, each of the radicals R⁵ represents H, m=5-30, n=31-250, w=1.5-30, y=0 to 1, z=0 to 1 and (y+z)>0.

Further it is to be regarded as preferred embodiment that in the said formulae (IV), (V) and (VI), the molar ratio of w to the sum (y+z) is 1:1 to 20:1 and preferably 2:1 to 12:1.

The representative of the third modification of the copolymer a₃) corresponding to formula (VI) should in particular be a nonionic polyether-polyester copolymer.

The terms “nonionic” and “uncharged” are to be understood as synonyms in this context.

Irrespective of the component a) and its preferred representatives a₁), a₂) and/or a₃), respectively contained in the formulation according to the invention, the present invention specifies that the formulation contain the component a) in proportions from 5 to 95% by weight, preferably of 10 to 60% by weight and particularly preferably of 15 to 40% by weight, based in each case on the total formulation.

### 1.4 Sulphonated Condensates

Sulphonic acid group containing s-triazines or naphthalene-formaldehyde condensates are broadly disclosed by prior art documents and frequently used as water reducing agents or plasticizers for cement based systems such as concrete.

β-naphthalene-sulphonate-formaldehyde condensates (“BNS”), also known as naphthalene-formaldehyde sulphonates (“NFS”) disperse cement particles by an electrostatic repulsion that results from adsorption processes.

BNS or NFS is suitable for making cement particles with high dispersion, low foaming and high range water reducing and thereof it is possible to save the hydraulic binder such as cements or calcium sulphite based binders to improve the cement mobility and workability. BNS is a high range admixture for concrete, cast-in-place, prefabricating, pump and curing and BNS has a good adaptability to cements and other hydraulic binders and is not corrosive to reinforcing bar and non poisonous and pollution-free. Therefore it has been broadly applied to the construction industry such as highways, bridges, tunnels, industrial buildings, prestressing force components and high range concretes.

Usually, such condensates suitable as plasticizer or dispersants are prepared by the reaction of aromatic sulphonic acids like naphthalene sulphonic acid with formaldehyde under ambient pressure and under temperatures up to 100° C.

The preparation and use of BNS is well known state of the art and disclosed for example in EP 0 214 412 A1 and DE-PS 2 007 603.

The effect and properties of BNS can be modified by changing the molar ratio between formaldehyde and the naphthalene component that usually is from 0.7 up to 3.5. The ratio between formaldehyde and the sulphonated naphthalene component preferably is from 0.8 to 3.5 to 1.

BNS condensates are added to the hydraulic binder containing composition in amounts from 0.01 up to 6.0 wt. %.

Melamine-sulphonate-formaldehyde-condensates (“MFS”) are broadly used as flow improving agents in the processing of hydraulic binder containing compositions such as dry mortar mixtures, pourable mortars and other cement bonded construction materials.

Melamine is used in this connection as representative of the s-triazine which is why these improving agents are known as MFS resins. They cause as well as the already mentioned BNS representatives a strong liquefying effect of the construction chemicals mixture without any undesired side effects occurring in the processing or in the functional properties of the hardened building material.

It is well known that commercially available flow improving agents based on melamine-formaldehyde-sulphite such as products of the Melment series of BASF Construction Polymers GmbH, Germany, cause an excellent liquefying effect even of low dosages of about 0.3 to 1.2 wt. %, relative to the weight of the hydraulic binder such as cement.

The liquefying effect of MFS products is achieved without lowering the surface tension of the water and binder system which usually is the case for the example with BNS products or flow improving agents with a surfactant-like polymers structure. The advantage of MFS resins is presumed to be due to the fact that no air avoids are introduced in to mortar during remixing process and the mortar density and strengths are not adversely effected after hardening.

In addition MFS resins provide the fresh mortar mixture with a good cohesive strength so that even when the flow properties are extreme separation phenomena within the construction composition do not occur. This phenomenon, also called as “segregation”, is feared especially in the production of self-flowing smoothing compositions which especially is the case with self-leveling screeds since its leads to a non-uniform layer structure of the screed due to floating of the fine material and sedimentation of the coarse grain.

As it is for the BNS technology also for MFS there is a broad prior art. In this connection as representative documents are mentioned DE 196 09 614 A1, DE 44 11 797 A1, EP 0 059 353 A1 and DE 195 38 821 A1:

DE 196 09 614 A1 discloses a water soluble polycondensation product based on an amino-s-triazine and its use as plasticizer in aqueous binder containing suspensions based on cement, lime and gypsum. These polycondensates are capable in two condensation steps whereby in a pre-condensation step the amino-s-triazine, the formaldehyde component and the sulphite are condensated at a molar ratio of 1 to 0.5:5.0 to 0.1:1.5. Melamine is a preferred representative of amino-s-triazines. Further suitable representatives are amino plast former selected from the group urea, thiourea, dicyandiamide or guanidine and guanidine salts.

According to DE 44 11 797 A1 sulfanilic acid containing condensation products based on amino-s-triazines that show at least two amino groups are prepared by using formaldehyde. The sulfanilic acid is used in amounts of from 1.0 to 1.6 mol per mol amino-s-triazine and neutralized in aqueous solution with an alkaline metal hydroxide or in earth alkaline metal hydroxide. In an additional step the formaldehyde is added in amounts of from 3.0 to 4.0 mol per mol amino-s-triazine at a pH value between 5.0 to 7.0 and at temperatures between 50 and 90° C. The final viscosity of the solution shall be between 10 and 60 cSt at 80° C.

According to EP 0 059 353 A1 highly concentrated and low viscose aqueous solutions of melamine/aldehyde resins are capable by reacting melamine and an aldehyde in an alkaline medium in a first step with a component selected from the group comprising alkali sulphate, earth alkali sulphate or (earth) alkali sulphonate or other suitable amino compounds to a pre-condensate. This mixture in an additional process step is reacted with another amino compound such as amino acids or amino carbonic acids and finally the resin solution is brought to an alkaline pH value.

DE 195 38 821 A1 discloses a condensate based on an amino-s-triazine with at least two amino groups and formaldehyde and a high content of sulphonic acid groups and a low content of formate. Such products can be prepared according to this document by reacting the amino-s-triazine, formaldehyde and a sulphite at a molar ratio of 1:3.0:6.0:1.51:2.0 in an aqueous solution and at a temperature between 60 and 90° C. and a pH value between 9.0 and 13.0 until the sulphite is no longer present. In an additional step the condensation process is conducted at a pH value between 3.0 and 6.5 and at temperatures between 60 and 80° C. until the condensation product at 80° C. shows a viscosity between 5 and 50 mm²/s. Finally, the condensation product is to be brought to a pH value between 7.5 and 12.0 or treated thermally by a pH≧10.0 and a temperature between 60 and 100° C.

According to the present invention the BNS and/or MFS dispersant is used in amounts of from 0.01 to 10 wt. % and preferably 0.1 to 5 wt. %, related to the hydraulic binder component. The molar ratio of the sulphonic group and related to the melamine component is of from 1.0 to 2.0 and the molar ratio of the formaldehyde related to the melamine component is from 2.5 to 5.0. Preferably the molar ratio melamine to sulphonic add to formaldehyde is 1:1.1:1.5:3.3:3.6.

Concerning the BNS component the molar ratio of formaldehyde to naphthalene sulphonic acid is from 1.3 to 1:3 to 1.

### 2. Polycondensation Product b)

As already discussed as state of the art admixtures in the form of dispersants are added to aqueous slurries or pulverulent inorganic or organic substances, such as days, silicate powder, chalk, carbon black, crushed rock and hydraulic binders, for improving their processability, i.e. kneadability, spreadability, sprayability, pumpability or flowability. Such admixtures are capable of preventing the formation of solid agglomerates and of dispersing the particles already present and those newly formed by hydration and in this way improving the processability. This effect is utilized in particular in a targeted manner in the preparation of construction material mixtures which contain hydraulic binders, such as cement, lime, gypsum, hemihydrate or anhydrite.

In order to convert these construction material mixtures based on said binders, into a ready-to-use, processable form, as a rule substantially more mixing water is required than would be necessary for the subsequent hydration or hardening process. The proportion of voids which is formed in the concrete body by the excess, subsequently evaporating water leads to significantly poorer mechanical strengths and resistances.

In order to reduce this excess proportion of water at a predetermined processing consistency and/or to improve the processability at a predetermined water/binder ratio, admixtures are used which are generally referred to as water-reducing agents or plasticizers. In practice, in particular polycondensates and copolymers are used as such agents.

WO 2006/042709 describes polycondensates based on an aromatic or heteroaromatic compound (A) having 5 to 10 C atoms or heteroatoms, having at least one oxyethylene or oxypropylene radical, and an aldehyde (C) selected from the group consisting of formaldehyde, glyoxylic acid and benzaldehyde or mixtures thereof, which result in an improved plasticizing effect of inorganic binder suspensions compared with the conventionally used polycondensates and maintain this effect over a longer period (“slump retention”). In a particular embodiment, these may also be phosphated polycondensates. The phosphated monomers used are, however, relatively expensive since they have to be separately prepared and purified.

Alternatively, there has been developed an economical dispersant, based on a phosphated polycondensate, for hydraulic binders, which dispersant is particularly suitable as a plasticizer/water-reducing agent for concrete and can be prepared in a simple manner and at low costs (non-disclosed prior art filed provisional as EP 081659155.3 in August 2008).

This object is achieved by a polycondensate containing
(I) at least one structural unit having an aromatic or heteroaromatic and a polyether side chain and
(II) at least one phosphated structural unit having an aromatic or heteroaromatic and
(III) at least one structural unit having an aromatic or heteroaromatic,
   structural unit (II) and structural unit (III) differing exclusively in that the OP(OH)₂ group of the structural unit (II) is replaced by H in structural unit (III), and structural unit (III) is not the same as structural unit (I).

The structural units (I), (II) and (III) of component b) of the claimed formulation can be described in more detail by the following general formulae

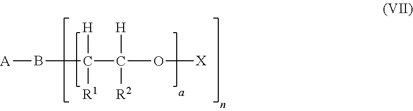

where
A are identical or different and are represented by a substituted or unsubstituted aromatic or heteroaromatic compound having 5 to 10 C atoms
where
B are identical or different and are represented by N, NH or O
where
n=2, if B=N and n=1, if B=NH or O
where
R¹ and R², independently of one another, are identical or different and are represented by a branched or straight-chain C₁- to C₁₀-alkyl radical, C₅- to C₈-cycloalkyl radical, aryl radical, heteroaryl radical or H
where
a are identical or different and are represented by an integer from 1 to 300
where
X are identical or different and are represented by a branched or straight-chain C₁- to C₁₀-alkyl radical, C₅- to C₈-cycloalkyl radical, aryl radical, heteroaryl radical or H,

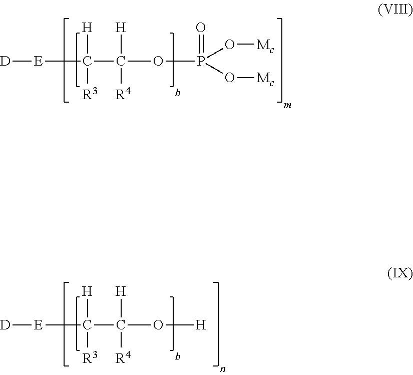

for (VIII) and (IX) in each case:
where
D are identical or different and are represented by a substituted or unsubstituted heteroaromatic compound having 5 to 10 C atoms
where
E are identical or different and are represented by N, NH or O
where
m=2 if E=N and m=1 if E=NH or O
where
R³ and R⁴, independently of one another, are identical or different and are represented by a branched or straight-chain C₁- to C₁₀-alkyl radical, C₅- to C₈-cycloalkyl radical, aryl radical, heteroaryl radical or H
where
b are identical or different and are represented by an integer from 0 to 300,
where
M is independently of one another an alkaline metal ion, alkaline earth metal ion, ammonium ion, organic ammonium ion and/or H,
c is 1 or in the case of alkaline earth metal ions A.

In a preferred embodiment, the polycondensate contains a further structural unit (X) which is represented by the following formula

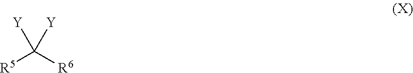

where
Y, independently of one another, are identical or different and are represented by (VII), (VIII), (IX) or further constituents of the polycondensate
where
R⁵ are identical or different and are represented by H, CH₃, COOM_{c} or a substituted or unsubstituted aromatic or heteroaromatic compound having 5 to 10 C atoms
where
R⁶ are identical or different and are represented by H, CH₃, COOM_{c} or a substituted or unsubstituted aromatic or heteroaromatic compound having 5 to 10 C atoms.

Here, R⁵ and R⁶ in structural unit (X), independently of one another, are preferably represented by H, COOM_{c} and/or methyl.

The molar ratio of the structural units (VII), (VIII), (IX) and (X) of the phosphated polycondensate according to the invention can be varied within wide ranges. This has proved to be expedient if the molar ratio of the structural units [(VII)+(VIII)+(IX)]:(X) is 1:0.8 to 3, preferably 1:0.9 to 2 and particularly preferably 1:0.95 to 1.2.

The molar ratio of the structural units (VII):[(VIII)+(IX)] in component b) is usually 1:15 to 15:1, preferably 1:10 to 10:1 and more preferably 1:5 to 3:1.

In a preferred embodiment, the molar ratio of the structural units (VIII):(IX) is adjusted to 1:0.005 to 1:10, preferrably 1:0.01 to 1:1, in particular 1:0.01 to 1:0.2 and more preferably 1:0.01 to 1:0.1.

The groups A and D in the structural units (VII), (VIII) and (IX) of the polycondensate are generally represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, it being possible for A and D to be chosen independently of one another and also in each case to consist of a mixture of said compounds. The groups B and E, independently of one another, are preferably represented by O.

The radicals R¹, R², R³ and R⁴ can be chosen independently of one another and are preferably represented by H, methyl, ethyl or phenyl, particularly preferably by H or methyl and especially preferably by H.

A in structural unit (VII) is preferably represented by an integer from 5 to 280, in particular 10 to 160 and particularly preferably 12 to 120 and b in structural units (VIII) and (IX) by an integer from 0 to 10, preferably 1 to 7 and particularly preferably 1 to 5. The respective radicals, the length of which is defined by a and b, respectively, may consist here of uniform building blocks, but a mixture of different building blocks may also be expedient. Furthermore, the radicals of the structural units (VII) or (VIII) and (IX), independently of one another, may each have the same chain length, a and b each being represented by a number. As a rule, however, it will be expedient if mixtures having different chain lengths are present in each case so that the radicals of the structural units in the polycondensate have different numerical values for a and independently for b.

Frequently, the phosphated polycondensate according to the present invention has a weight average molecular weight of 4000 g/mol to 150 000 g/mol, preferably 10 000 to 100 000 g/mol and particularly preferably 20 000 to 75 000 g/mol.

As a rule, the phosphated polycondensate according to the invention is present in the claimed formulation as aqueous solution which contains 2 to 90% by weight of water and 98 to 10% by weight of dissolved dry matter, preferably 40 to 80% by weight of water and 60 to 20% by weight of dissolved dry matter, and more preferably 45 to 75% by weight of water and 55 to 25% by weight of dissolved dry matter. The dry matter then substantially comprises the anhydrous phosphated polycondensate, where further components, such as antifoams and other auxiliaries, can advantageously also be present.

In a further embodiment the polycondensate b) is present in the formulation in proportions of 5 to 100% by weight, preferably of 10 to 60% by weight and particularly preferably of 15 to 40% by weight, based in each case on the total formulation.

In a particular embodiment, the invention furthermore envisages a sodium, potassium, ammonium and/or calcium salt and preferably a sodium and calcium salt, of the phosphated polycondensate.

The present invention also relates to a process for the preparation of a phosphated polycondensate, it being regarded as essential that the polycondensation and the phosphation be carried out in a reaction mixture. This is to be understood as meaning that the phosphated component formed in the reaction solution needs neither be purified nor isolated. The phosphation can be carried out before, during or after the polycondensation. It is to be regarded as being preferred here to carry out both the phosphation and the polycondensation in the same reaction vessel.

In a preferred embodiment, the reaction mixture with regard to the polycondensate component b) contains at least
(Ia) a monomer having a polyether side chain and an aromatic or heteroaromatic,
(IIa) a monomer having an aromatic or heteroaromatic unit, (IIIa) being partially phosphated during the reaction and forming the monomer (IIa) and/or, in the polycondensate, the structural unit (IIa),
(IVa) a monomer having an aldehyde group and a phosphating agent,
   structural unit (IIa) not being the same as structural unit (Ia).

The monomers (Ia), (IIa), (IIIa) and (IVa) and, in the polycondensate, the structural unit (IIa) are preferably represented by the following general formulae:

Monomer (Ia):

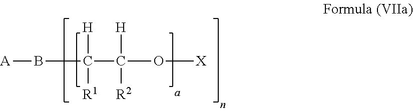

where
A are identical or different and are represented by a substituted or unsubstituted aromatic or heteroaromatic compound having 5 to 10 C atoms
where
B are identical or different and are represented by N, NH or O
where
n=2 if B=N and n=1 if B=NH or O
where
R¹ and R², independently of one another, are identical or different and are represented by a branched or straight-chain C₁- to C₁₀-alkyl radical, C₅- to C₈-cycloalkyl radical, aryl radical, heteroaryl radical or H
where
a are identical or different and are represented by an integer from 1 to 300
where
X are identical or different and are represented by a branched or straight-chain C₁- to C₁₀-alkyl radical, C₅- to C₈-cycloalkyl radical, aryl radical, heteroaryl radical or H;

Monomer (IIa):

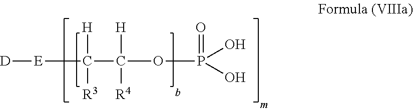

Monomer (IIIa):

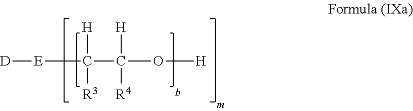

for formulae (VIIIa) and (IXa) in each case:
where
D are identical or different and are represented by a substituted or unsubstituted heteroaromatic compound having 5 to 10 C atoms
where
E are identical or different and are represented by N, NH or O
where
m=2 if E=N and m=1 if E=NH or O
where
R³ and R⁴, independently of one another, are identical or different and are represented by a branched or straight-chain C₁- to C₁₀-alkyl radical, C₅- to C₈-cycloalkyl radical, aryl radical, heteroaryl radical or H
where
b are identical or different and are represented by an integer from 0 to 300;

Monomer (IVa):

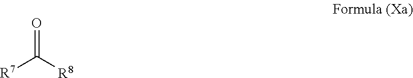

where
R⁷ are identical or different and are represented by H, CH₃, COOH and/or a substituted or unsubstituted aromatic or heteroaromatic compound having 5 to 10 C atoms where
R⁸ are identical or different and are represented by H, CH₃, COOH and/or a substituted or unsubstituted aromatic or heteroaromatic compound having 5 to 10 C atoms.

The present invention provides different variants of the reaction procedure. One possibility consists in first reacting the monomer (IIIa) with a phosphating agent and subjecting the monomer (IIa) thus obtained to polycondensation with the monomers (Ia), (IIIa) and (IVa). The monomer (IIIa) may originate here from an incomplete reaction during the phosphation reaction or can be deliberately added to the reaction mixture after the phosphation reaction.

However, it is also possible to subject the monomers (Ia), (IIIa) and (IVa) to a polycondensation and then to read the polycondensate obtained with a phosphating agent. In a further embodiment, the monomers (Ia), (IIIa) and (IVa) and the phosphating agent are reacted simultaneously.

In particular, polyphosphoric acid and/or phosphorous pentoxide have proved suitable here as phosphating agents.

As a rule, the polycondensation is carried out in the presence of an acidic catalyst, this preferably being sulphuric acid, methanesulphonic add, para-toluenesulphonic acid or mixtures thereof.

The polycondensation and the phosphation are advantageously carried out at a temperature between 20 and 140° C. and a pressure between 1 and 10 bar. In particular, a temperature range between 80 and 110° C. has proved to be expedient. The duration of the reaction may be between 0.1 and 24 hours, depending on temperature, the chemical nature of the monomers used and the desired degree of crosslinking. Once the desired degree of crosslinking has been reached, which can also be determined, for example, by measurement of the viscosity of the reaction mixture, the reaction mixture is cooled.

According to a particular embodiment, the reaction mixture is subjected to a thermal aftertreatment at a pH between 8 and 13 and a temperature between 60 and 130° C. after the end of the condensation and phosphation reaction. As a result of the thermal aftertreatment, which advantageously lasts for between 5 minutes and 5 hours, it is possible substantially to reduce the aldehyde content, in particular the formaldehyde content, in the reaction solution.

In a further particular embodiment, the present invention envisages subjecting the reaction mixture to a vacuum aftertreatment at pressures between 10 and 900 mbar after the end of the condensation and phosphation reaction, for reducing the aldehyde content. Furthermore, however, other methods known to the person skilled in the art for reducing the formaldehyde content may also be used. An example is the addition of small amounts of sodium bisulphite, ethylene urea and/or polyethylenimine.

The phosphated polycondensates obtained by these processes can be used directly as component b). In order to obtain a better shelf life and better product properties, it is advantageous to treat the reaction solutions with basic compounds. It is therefore to be regarded as being preferred to react the reaction mixture after the end of the reaction with a basic sodium, potassium, ammonium or calcium compound. Sodium hydroxide, potassium hydroxide, ammonium hydroxide or calcium hydroxide has proved to be particularly expedient here, it being regarded as being preferred to neutralize the reaction mixture. However, other alkali metal and alkaline earth metal salts and salts of organic amine are suitable as salts of the phosphated polycondensates.

Furthermore, however, the present invention also provides the preparation of mixed salts of the phosphated polycondensates. These can expediently be prepared by reacting the polycondensates with at least two basic compounds.

Thus, by a targeted choice of suitable alkali metal and/or alkaline earth metal hydroxides, it is possible by neutralization to prepare salts of the polycondensates according to the invention, with which the duration of the processability of aqueous suspensions of inorganic binders and in particular of concrete can be influenced. While a reduction in the processability over time is observable in the case of the sodium salt, a complete reversal of this behavior takes place in the case of the calcium salt of the identical polymer, a smaller water reduction (smaller slump) occurring at the beginning and increasing with time. As a result of this, sodium salts of the phosphated polycondensates lead over time to a decrease in the processability of the binder-containing material, such as, for example, concrete, mortar or gypsum slurries, whereas the corresponding calcium salts lead with time to improved processability. By suitable choice of the amount of sodium and calcium salts of the phosphated polycondensates used, the development of the processability of binder-containing materials can thus be controlled as a function of time. Expediently, the corresponding phosphated polycondensates, which consist of sodium and calcium salts, are prepared by reaction with a mixture of basic calcium and sodium compounds, in particular calcium hydroxide and sodium hydroxide.

According to the present invention, the catalyst used can also be separated off. This can expediently be effected via the salt formed during the neutralization. If sulphuric acid is used as a catalyst and the reaction solution is treated with calcium hydroxide, the calcium sulphate formed can be separated off, for example, in a simple manner by filtration.

Furthermore, by adjusting the pH of the reaction solution to 1.0 to 4.0, in particular 1.5 to 2.0, the phosphated polycondensate can be separated from the aqueous salt solution by phase separation and can be isolated. The phosphated polycondensate can then be taken up in the desired amount of water.

However, other methods known to the person skilled in the art, such as dialysis, ultrafiltration or the use of an ion exchanger, are also suitable for separating off the catalyst.

Surprisingly, with a phosphated polycondensate according to the invention as sole dispersing component an improved efficiency was found in comparison with the polycondensates known in the prior art. As additional favorable effect a significantly decreased retardation of the setting and hardening of the various construction compositions and especially of gypsum based slurries compared to other dispersants is to be observed, independently from the dosage of the dispersing component. This effect of the polycondensate component as well as an expedient influence on the pore structure surprisingly can be observed.

Additionally, it has proved particularly advantageous that the phosphated polycondensates according to the invention can be prepared by a very economical process, no further purification of intermediates being required. In particular, no wastes which have to be disposed of form in the process according to the invention. Thus, the claimed process also constitutes further progress compared with the prior art from environmental points of view. The reaction mixture obtained can be put directly to the intended formulation optionally after treatment with basic compounds.

It's also worth to underline that in clay containing gypsum slurries significantly less amounts of the phosphated polycondensate are necessary compared to branched comb polymer having polyether side chains (such as but not limited to polycarboxylate ether), a naphthalene sulphonate-formaldehyde condensate (“BNS”) and a melamine sulphonate-formaldehyde condensate (“MSF”), whereby these phosphated polycondensates are also suitable for masking days, preferably in activated form, in the gypsum slurry. A typical day activation can be by methods of calcination, such as treatments at elevated temperatures.

### 3. Additional Components and Aspects

In a specific embodiment the claimed formulation contains additionally to the components a) and b) at least one antifoaming agent c) and/or a component d) having a surface-active effect, the components c) and d) being structurally different from one another.

The antifoaming agent c) is preferably selected from the group consisting of a mineral oil, a vegetable oil, a silicon oil, a silicon containing emulsion, a fatty add, a fatty add ester, an organic modified polysiloxane, a borate ester, an alkoxylate, a polyoxialkylene copolymer, ethylene oxide (EO)-propylene oxide (PO) block polymer, acetylenic diols having defoaming properties and a phosphoric ester having the formula P(O) (O—R₈)₃₋ₓ(O—R₉)ₓ wherein P represents phosphorus, O represents oxygen and R₈ and R₉ are independently a C₂-C₂₀ alkyl or an aryl group and x=0, 1, 2, whereby an alkyl group with C₂-C₈ is preferred.

Preferably said antifoaming agent c) comprises tri-alkylphosphate and more preferably triiso-butylphosphate, a polyoxypropylen copolymer and a glycerol/alcohol acetate.

The invention additionally comprises an admixture wherein said antifoaming agent c) comprises a mixtures of a tri-alkylphosphate and a polyoxypropylene copolymer.

The second optional component of the formulation, namely the surfactant, is preferably selected from the group consisting of a ethylene oxide/propylene oxide (EO/PO) block copolymer, a styrene/maleic acid copolymer, a fatty alcohol alkoxylate, an alcohol ethoxylate R₁₀-(EO)-H with R₁₀ being an aliphatic hydrocarbon group having from 1 to carbon atoms, acetylenic diols, monoalkylpolyalkylenes, ethoxylated nonylphenols, alkylsulfates, alkylethersulfats, alkylethersulfonates, alkyl ether carboxylates.

More preferably surfactant component d) comprises an alcohol having a polyalkylene group consisting of a carbon chain length of 2 to 20 carbon atoms, with a specific carbon chain length of C₃-C₁₂.

Advantageously the formulation according to the invention comprises an aqueous composition that contains the antifoaming agent component c) in free form or attached to the dispersing components a), and/or b). If the antifoaming agent is attached to the dispersing components it can be physically or chemically attached, and the chemically attached in this case in polymerized and/or grafted form being preferred. When chemically attached, the antifoaming agent c) also can be considered as a third co-monomer of the copolymeric dispersing components a₁), a₂), a₃). In its free form the antifoaming agent c) is a blend component of the formulation. Thus, antifoaming agent component c) is either physically and/or chemically attached to the dispersing components a₁), a₂) and/or a₃) and/or it is a free form component and therefore constituent of a blend.

In a further embodiment the antifoaming component c) is present in amounts of 0.01 to 10% by weight and/or the surface-active component d) is present in amounts of 0.01 to 10% by weight, based in each case on the total weight of the formulation. According to a preferred embodiment the antifoaming formulation according to any of Claims 52 to 61, characterized in that the antifoam c) and/or the surface-active component d), independently of one another, are present in each case in an amount of 0.01 to 5% by weight, based in each case on the total weight of the formulation. The present invention additionally comprises an embodiment whereby the formulation in addition to the components a) and b) and optionally c) and/or d), contains at least one further compound e) selected from the group consisting of a polymer having a low charge, a neutral polymer or polyvinyl alcohol. This component e) and particularly its specific role in systems containing calcium sulfate as hydraulic binder has been teached in the unpublished provisional European Patent application EP 08171022.0. The component e) plays a major role in gypsum composition with certain day contents.

In the use of clay-containing forms of gypsum, and particularly natural gypsum, it can be observed that considerable quantities of the dispersant (fluidizing agent) used are absorbed or adsorbed by the day mineral, as a result of which they are no longer available for the fluidization of the gypsum hemihydrate in the gypsum mixture.

To solve this problem, attempts were made to use so-called sacrificial substances, which in competition with the dispersant bind more strongly to the surface of the clay particles and in this way either mask these so that they are no longer accessible to the dispersant, or largely flocculate the day particles.

According to the mentioned European application there has been provided a formulation based on a branched comb polymer with ethylene oxide (EO) units in the side-chains for the dispersion of day-containing gypsum mixtures. These formulations are capable of masking clay minerals such as are in particular contained in natural gypsum to a sufficient extent that the surfaces thereof are no longer available for the adsorption of dispersants. They have no adverse effect on the fluidization and consistency of the wet and unhardened gypsum mixture and they are stable to the temperatures used in the drying of the gypsum products, so that no odour problems arise.

In this connection and with regard to clay-containing gypsum compositions a copolymer component a₂) is to prefer that is based on a hydrolysable monomer A having an active binding site for at least one component of the clay-containing gypsum mixture.

With component e) according to the present invention, the surface of the clay particles can be more effectively coated through the bunching of flexible EO side-chains on a polymer backbone or the clay particles can themselves be better flocculated overall. Because of the lower charge density, the component e) can adsorb mainly on the clay and not on the binder such as gypsum hemihydrate.

Evidently a not insignificant role in the effects is played by the side-chains of the “sacrificial substance”. These must include EO units; however, the side-chains can also in addition have polyethylene oxide (PO) units. The same applies for the main substance contained in the formulation according to the invention, the comb polymer with dispersant properties; this can contain either EO or PO units or both in its side-chains. Here the mixed modifications can also each be implemented in at least one, that is the same, side-chain.

Overall, it can be stated that from the chemical point of view the component e) optionally contained in the formulation according to the invention as a sacrificial substance to some extent differs only insignificantly from the dispersants a) commonly used in clay-containing gypsums, since it also consists inter alia of polycarboxylate ethers. The difference consists however in the charge state, since only representatives with low or neutral charge are possible as the sacrificial substance. In other words, the manufacture of gypsum products in particular can also be effected with the aid of dispersants which inter alia consist of copolymer mixtures wherein the low-charge or neutral polymer fractions predominantly mask the clay minerals and thus enable the remaining dispersant content to exert its actual fluidizing agent action.

The advantageous action of the formulation according to the present invention and mainly based on component e) is displayed in essentially all day-containing gypsum mixtures. However, the positive action is especially pronounced in gypsum systems which contain at least one representative of the series calcium sulphate, calcium sulphate semihydrate or calcium sulphate hemihydrate, anhydrite and gypsum.

The clay fraction in the gypsum mixture should preferably be swellable and in particular water-swellable and derive from the series of the smectites, montmorillonites, bentonites, vermiculites, hectorites or from the series of the kaolins, feldspars and micas such as for example illite and mixtures thereof.

Essentially, care should be taken that the clay contents in the gypsum mixtures do not exceed certain limits. For this reason, the present invention recommends day contents in the gypsum mixtures of ≦20 wt. %, preferably, 15 wt. %, preferably ≦10 wt. % and especially preferably between 0.5 and 5 wt. %, each based on the gypsum component.

For the polymer component e), proportions from 0.01 to 0.40 wt. %, preferably from 0.02 to 0.30 wt. %, preferably from 0.03 to 0.15 wt. % and especially preferably from 0.5 to 0.10 wt. %, each again based on the gypsum component, are recommended.

In a further embodiment of the invention the formulation contains the component e) in amounts of 1 to 50% by weight, preferably of 5 to 40% by weight and particularly preferably in amounts of 10 to 30% by weight, based in each case on the total weight of the formulation.

In the context of the present invention, the polymer component e), which reacts with the clay particles in the gypsum mixture, is of particular significance. In the case of a low-charge polymer as component e) this should be branched, the side-chain preferably consisting of a polyether. Polycarboxylate ethers and/or polycarboxylate esters, preferably with EO side-chains and with a carboxylate content up to 83 mol. %, and preferably up to 75 mol. % are to be regarded as especially preferred in this connection.

As already stated, component a) of the formulation should advantageously include at least one polycarboxylate derivative (ether, ester); in particular if this has a low charge content, it cannot on account of its specific properties adsorb for example onto gypsum to the necessary extent. For this reason, the generally known dispersant action of polycarboxylate ethers and esters in particular does not occur to the necessary extent in this case. Hence the content of the charge-bearing component is important for the dispersant action of such representatives. Since the copolymer components a₁), a₂) and a₃) and, to some extent, depending on its chemical character, also component e) can compete with one another as regards the dispersant action, it is advantageous overall to select the respective contents in the formulation according to the invention such that the copolymer component a) can exhibit its dispersant action to the maximum and the component e) because of its charge properties has as little dispersant action as possible, but instead is maximally adsorbed on the clay particles.

If a low-charge polymer with a polyether side-chain is used as component e), then this should be made up of at least one monomer selected from the series polyether monoacrylate, polyether monomethacrylate, polyether monoallyl ether, polyether monomaleate, monovinylated polyether or mixtures thereof. In the case of a polyether, this can be an alkylene oxide polymer with a molecular weight from 500 to 10 000, preferably from 750 to 7500 and in particular from 1000 to 5000. As representative alkylene oxide polymers, those based on an ethylene oxide, propylene oxide, butylene oxide or mixtures thereof may be mentioned.

Low-charge polymers which are built up of at least one monomer selected from the series polypropylene glycol acrylates, polypropylene glycol methacrylates, polyethylene glycol acrylates, polyethylene glycol methacrylates, polypropylene glycol monovinyl ethers, polythylene glycol monovinyl ethers, alkoxy or aryloxypolyethylene glycol acrylates, alkoxy or aryloxypolythylene glycol methacrylates, alkoxy or aryloxy-polyethylene glycol monovinyl ethers, acrylates, methacrylates and monovinyl ethers of an oxyethylene and oxypropylene block or randomized copolymer, polypropylene glycol allyl ether, polyethylene glycol allyl ether, polyethylene glycol monomaleate, polypropylene glycol monomaleate and any mixtures thereof have been found especially suitable.

It can be seen as preferred embodiment that the polymer e) having a low charge carries a carboxylic acid group, preferably selected from the series consisting of acrylic acid, methacryl acid, maleic acid, fumaric acid, itaconic acid or anhydrides thereof.

According to the invention, the low-charge polymer can also bear a carboxylic acid and/or sulphonic acid groups. In this case, the present invention specifies that the carboxylic acid group is preferably at least one representative of the series acrylic acid, methacrylic acid, maleic acid, fumaric acid, itaconic acid or anhydrides thereof. 2-Acrylamido-2-methylpropanesulphonic acid (AMPS), vinylsulphonic acid, allyl ether sulphonic add, 2-sulphoethylmethacrylic acid, styrenesulphonic acid, methallyl-sulphonic acid, and sodium, potassium and ammonium salts and any mixtures thereof, are preferred representatives of compounds which make sulphonic acid groups available. AMPS and vinylsulphonic acid are to be regarded as especially preferable.

In the case of neutral polymers as component e), these should be made up of neutral monomer building blocks, which are in particular selected from the series acrylic acid alkyl esters and methacrylic acid alkyl esters and hydroxyalkyl esters thereof with up to 5 carbon atoms. Particularly suitable in this case are hydroxyethyl acrylate and hydroxypropyl acrylate and hydroxyethyl methacrylate and hydroxypropyl methacrylate. Also possible are vinyl acetate, N-vinylpyrrolidone, N-vinylcaprolactam, styrene and methylstyrene.

In a further embodiment the present invention relates to a formulation that contains as additional further component f) a calcium-silicate-hydrate (C—S—H) containing composition.

It is well known to a skilled person that admixtures for building material mixtures comprising hydraulic binders typically also contain hardening accelerators which shorten the setting time of the hydraulic binder. According to WO 02/070425, calcium silicate hydrate (C—S—H), in particular present in dispersed (finely or particularly finely dispersed) form, can be used as such a hardening accelerator. However, commercially available C—S—H or corresponding C—S—H dispersions may be regarded only as hardening accelerators which have little effect.

By the non-published provisional application EP 08163468.5 of September 2008 a composition acting as a plasticizer and moreover showing a good performance as a hardening accelerator has been provided.

According to the present invention the C—S—H containing composition is prepareble by reaction of a water-soluble calcium containing compound with a water-soluble silicate containing compound, the reaction of the water-soluble calcium containing compound with the water-soluble silicate containing compound being carried out in the presence of an aqueous solution preferably containing a water-soluble copolymer that preferably is a dispersant for hydraulic binders and selected from at least a representative of component a) and/or b).

In principle, only relatively slightly water-soluble compounds are also suitable in each case as water-soluble calcium compounds and water-soluble silicate compounds, although readily water-soluble compounds (which dissolve completely or virtually completely in water) are preferred in each case. However, it must be ensured that a reactivity sufficient for the reaction is present in an aqueous environment with the corresponding reactant (either water-soluble calcium compound or water-soluble silicate compound). It is probably to be assumed that the reaction takes place in aqueous solution but a water-insoluble inorganic compound (C—S—H) is usually present as a reaction product.

In the context of the present invention, comb polymers are to be understood as meaning those polymers which have relatively long side chains (having a molecular weight of in each case at least 200 g/mol, particularly preferably at least 400 g/mol) on a linear main chain at more or less regular intervals. The lengths of these side chains are frequently approximately equal but may also differ greatly from one another (for example when polyether macromonomers having side chains of different lengths are incorporated in the form of polymerized units).

In principle, component f) acts as accelerator and in a preferred embodiment contains an inorganic and an organic component. The inorganic component may be regarded as modified, finely disperse calcium silicate hydrate (C—S—H) which may contain foreign ions, such as magnesium and aluminium. The C—S—H can be prepared in the presence of the comb polymer plasticizer (organic component). Usually, a suspension containing the C—S—H in finely disperse form is obtained, which suspension firstly acts as a plasticizer and secondly effectively accelerates the hardening process of hydraulic binders.

The inorganic component can in most cases be described with regard to its composition (not with regard to particle size, specific surface area, etc) by the following empirical formula:
a CaO, SiO₂, b Al₂O, c H₂O, d X, e W
X is an alkali metal
W is an alkaline earth metal

| | | |
|---|---|---|
| 0.1 ≦ a ≦ 2 | preferably | 0.66 ≦ a ≦ 1.7 |
| 0 ≦ b ≦ 1 | preferably | 0 ≦ b ≦ 0.1 |
| 1 ≦ c ≦ 6 | preferably | 1 ≦ c ≦ 6.0 |
| 0 ≦ d ≦ 1 | preferably | 0 ≦ d ≦ 0.4 |
| 0 ≦ e ≦ 2 | preferably | 0 ≦ e ≦ 0.1 |

According to the present invention the C—S—H shows a calcium/silicium (Ca/Si)-molar ratio of 0.5 to 2.0, preferable 0.7 to 1.8, more preferable 1.6 to 1.7. The average particle size of C—S—H is smaller than 10 μm, preferable smaller than 1 μm, more preferable smaller than 0.2 μm, measured by light scattering with the equipment Master Sizer 2000 from the Malvern Company. In a further preferred embodiment the average particle size of C—S—H is greater 0.01 μm, preferable 0.1 μm to 1.0 μm, more preferable 0.2 μm to 0.5 μm.

With other words the dispersant that is used for this method of preparation can be identical to the representatives of the dispersing component a) and/or b) of the formulation. The dispersing agent in this method of preparation is necessary for achieving a small particle size distribution of the C—S—H compound.

Preferably that C—S—H containing composition is preperable by reaction of a calcium oxide, a calcium carbonate and/or a calcium hydroxide with a silicium dioxide during milling, the reaction being carried out in the presence of an aqueous solution that preferably contains a water-soluble copolymer that preferably is a dispersant for hydraulic binders and selected from at least a representative of component a) and/or b).

In a further preferred embodiment of the invention, the water-soluble calcium compound is mixed in a first step, with the aqueous solution which contains a water-soluble comb polymer suitable as a plasticizer for hydraulic binders, so that a mixture preferably present as a solution is obtained, to which the water-soluble silicate compound is added in a subsequent second step.

The aqueous solution may also contain one or more further solvents in addition to water.

In a further preferred embodiment, the aqueous solution containing the dispersant and preferably one that is selected from component a) and/or b) furthermore has the water-soluble calcium compound and the water-soluble silicate compound as components dissolved in it.

In general, the components used are used in the following ratios:

i) 0.01 to 75, preferably 0.01 to 5, % by weight of water-soluble calcium compound,
ii) 0.01 to 75, preferably 0.01 to 5% by weight of water-soluble silicate compound,
iii) 0.001 to 60, preferably 0.1 to 15% by weight of water-soluble comb polymer suitable as a plasticizer for hydraulic binders (preferably component a) and/or b))
iv) 24 to 99, preferably 90 to 99, % by weight of water.

Frequently, the aqueous solution also contains, in addition to silicate and calcium ions, further dissolved ions which are preferably provided in the form of dissolved aluminium chloride and/or dissolved magnesium chloride.

The water-soluble dispersant can be a comb polymer and be present as a copolymer which contains, on the back bone, side chains having ether functions and acid functions.

As a rule, the water-soluble comb polymer is present as a copolymer which is produced by free radical polymerization in the presence of acid monomer and polyether macromonomer, so that altogether at least 45 mol %, preferably at least 80 mol %, of all structural units of the copolymer are produced by incorporation of acid monomer and polyether macromonomer in the form of polymerized units. Acid monomer is to be understood as meaning monomers which are capable of free radical copolymerization, have at least one carbon double bond, contain at least one acid function and react as an acid in an aqueous medium. Furthermore, acid monomer is also to be understood as meaning monomers which are capable of free radical copolymerization, have at least one carbon double bond, form at least one acid function in an aqueous medium as a result of a hydrolysis reaction and react as an acid in an aqueous medium (example: maleic anhydride).

In the context of the present invention, polyether macromonomers are compounds which are capable of free radical copolymerization, have at least one carbon double bond, and have at least two ether oxygen atoms, with the proviso that the polyether macromonomer structural units present in the copolymer have side chains which contain at least two ether oxygen atoms.

For further details reference is made to the description of the components a) and b) of the claimed formulation hereto.

Often, the water-soluble calcium compound is present as calcium chloride, calcium nitrate, calcium formate, calcium acetate, calcium bicarbonate, calcium bromide, calcium carbonate, calcium citrate, calcium chlorate, calcium fluoride, calcium gluconate, calcium hydroxide, calcium hypochloride, calcium iodate, calcium iodide, calcium lactate, calcium nitrite, calcium oxalate, calcium phosphate, calcium propionate, calcium silicate, calcium stearate, calcium sulphate, calcium sulphate hemihydrate, calcium sulphate dihydrate, calcium sulphide, calcium tartrate and/or calcium aluminate, tricalcium silicate and/or dicalcium silicate.

The water-soluble calcium compound is preferably present as calcium chloride, calcium nitrate and/or calcium formate.

Often, the water-soluble silicate compound is present as sodium silicate, potassium silicate, waterglass, aluminium silicate, tricalcium silicate, dicalcium silicate, calcium silicate, silicic acid, sodium metasilicate and/or potassium metasilicate.

The water-soluble silicate compound is preferably present as sodium metasilicate, potassium metasilicate and/or waterglass.

In principle, a calcium silicate (provided that it is soluble) may be used both as a silicate source and as a calcium source. In many cases, however, this is not preferred. As a rule, species of different types are used as the water-soluble silicate compound and as the water-soluble calcium compound.

According to the present invention the formulation is a liquid or a powder and preferably a redispersant powder.

The powder form of the formulation can be achieved by any method known to a skilled person. Preferred is the spray drying method that is also suitable for getting the formulation of the invention as redispersant powder.

### 4. Method of Use

Beside the formulation itself a method of use of the formulation states a further embodiment of the present invention.

In this connection the use of the formulation for controlling the flowability of aqueous suspensions used in construction chemistry and in particular in aqueous suspensions containing hydraulic and/or latent hydraulic binders is of main interest. The formulation is used in particular as composition with dispersing properties. Regarding the aqueous suspensions it is a further embodiment that these compositions contain, as a hydraulic binder at least one representative selected from the group consisting of cements and calcium sulphate-based compounds, in particular calcium sulphate hemihydrate, anhydrite or gypsum. The aqueous suspension according to the present invention preferably is based on a dry mortar composition or a flooring composition. In a further embodiment the flooring composition contains calcium sulphate or cement or mixtures thereof, and preferably is a self-leveling flooring composition.

Independent from the specific use the formulation according to the present invention is to be used in amounts of 0.001 to 8.0% by weight, in particular 0.005 to 5.0% by weight, preferably 0.01 to 2.0% by weight and particularly preferably 0.05 to 1.0% by weight, based in each case on the total composition of the suspension.

Finally, the present invention comprises the option that the formulation is used together with other admixtures or compositions, preferably with flowability controlling and/or dispersing properties, and more preferably together with at least one dispersant of the type of component a) and/or the polymerisation product b) of the formulation.

This means that the combination of component a) and component b) can be used as formulation according to the present invention and additionally that this formulation can be used together with other compounds, additives, admixtures or compositions. In consequence components a) and b) can be used as substantial constituents of the formulation and additionally as single compounds together with such formulation. This kind of use can be practiced stepwise, that means that either the formulation or the additional dispersants are added to the hydraulic binder containing composition in the first step of use and that additional amounts of the formulation its components are added in up following process steps.

One or more of the problems in connection with the production, manufacture and providing of building panels and especially gypsum boards are solved by each of the embodiments of the panel provided by the invention that includes a matrix of calcium sulfate dihydrate crystals and two different types of dispersants. One dispersant is a dispersant component (hereafter dispersant component) and another dispersant is a polycondensation component (hereafter referred to as the “polycondensation component”). The dispersant component has dispersing properties and is a comb-branched polymer with polyether side chains, naphthalene sulfonate-formaldehyde condensate, melamine sulfonate-formaldehyde condensate or mixture of two or more thereof. The polycondensation component includes three repeating units. A first polycondensation repeating unit has a polyether side chain and either an aromatic sub-unit or a heteroaromatic sub-unit. A second polycondensation repeating unit has a OP(OH)₂ group and either an aromatic sub-unit or a heteroaromatic sub-unit. A third polycondensation repeating unit has an aromatic sub-unit or a heteroaromatic sub-unit. The second polycondensation repeating unit and the third polycondensation repeating unit differ exclusively in that the OP(OH)₂ (“phosphate”) groups of the second polycondensation repeating unit are replaced by H in the third polycondensation repeating unit, and the third polycondensation repeating unit is not the same as the first polycondensation repeating unit.

A method of making the gypsum panel includes combining stucco, water and a first dosage of a first dispersant to form a slurry, the first. A second dosage of a second dispersant is added to the slurry. Properties of the gypsum slurry are tested and it is formed into a product. The product sets and properties of the product are identified. The first dosage or the second dosage is changed based on the properties of the slurry or product.

Using both types of dispersants brings to a panel product the advantages of both. The dispersant component has greater efficacy for water reduction than the polycondensation component, while the polycondensation component minimizes the set retardation of the gypsum slurry. Simultaneous use of both dispersant types allows these properties to be balanced over a wide range of variables, including the source and quality of raw materials, stucco crystal form, the number and amounts of other additives used. Manufacturing plants using different raw materials are able to utilize a different ratio of the dispersant component to the polycondensation component. Use of the two dispersants also allows for production of a cost effective product depending on the costs of fuel and raw materials.

In slurries additionally including foam to produce foam voids in the panel products, surprisingly, it has also been found that the choice of some of the dispersant components allows for better control of the foam void structure in gypsum panel products. Some of the dispersant components have minimal effect on the size and distribution of the foam voids left behind by the foam added to the gypsum slurry, while other dispersant components produce a noticeable effect. This effect is caused by the additives' effects upon the stability of the foam. The ability to choose the dispersant types and proportions to achieve a desired degree of foam stability would provide another means of engineering an appropriate foam void structure to provide desired balance of strength and density to the gypsum panel product.

Optionally, the panel also includes a defoaming component to have a further effect on achieving the desired balance. The defoaming component is present either as a free compound in solution or as a moiety on the dispersant component or the polycondensation component.

The method of adjusting the relative amounts of two dispersants relative to each other adds another degree of freedom in the process control. Properties such as the slurry fluidity, the hydration speed and the foam bubble size are affected by a number of additives. Balancing amounts of set accelerator, dispersant, foaming agent, antifoaming agent and the like makes it difficult to achieve the desired properties. Selection of dispersants that promote different effects in the properties provides a way of achieving the desired hydration rate, bubble size distribution and fluidity.

### BRIEF DESCRIPTION OF THE DRAWINGS

FIG. 1 is a photograph of the interior of a sample having a small void size distribution;

FIG. 2 is a photograph of the interior of a sample having a medium void size distribution;

FIG. 3 is a photograph of the interior of a sample having a large void size distribution;

FIG. 4 is a graphic representation of the amount of dispersant from Table 1 used at various water to stucco ratios using several different dispersant ratios;

FIG. 5 is a graphic representation of the amount of dispersant used at various amounts of set accelerator for several different dispersant ratios; and

FIG. 6 is a graphic representation of the ratio of soap that produces unstable foam to soap that produces stable foam at various water to stucco ratios for several different dispersant ratios.

### DETAILED DESCRIPTION OF THE INVENTION

Gypsum panels are made from a slurry on high-speed manufacturing equipment. Efficient manufacturing of gypsum slurries or panels requires control over the product properties. A gypsum panel including additives and a method for adjusting these additives provides improved control over the manufacturing process and an improved product.

As used herein, “efficacy” is a measure of a dispersants ability to improve the fluidity of a gypsum slurry at constant dispersant dosage. If improved fluidity is not needed, improvements in efficacy can be used to reduce the amount of water used to fluidize the slurry while holding the fluidity, or “slump,” constant. A decision as to which of these choices to select is based on a number of things including the product to be made, the raw materials, process configurations and economics.

“Hydration speed” is a measure of the speed of the hydration reactions. In some manufacturing facilities, it is important to achieve a certain degree of set, typically 50%, at the knife where the gypsum is cut into individual panels.

“Gypsum bubble structure” refers to the sizes of individual bubbles in the slurry after the foam has been added. It should be understood that the foam bubbles in the slurry form the foam voids in the set gypsum panel when the calcium sulfate dihydrate crystals form around the soap bubble. Thus, the sizes of the voids are determined by the sizes of the bubbles from which they are made. Three types of structures are often achieved in panels of constant density, each of which can be desirable in different products. A small void size structure has small bubbles in a relatively narrow size range. An example of a panel having a small void size structure is shown in FIG. 1. This structure is preferred in some products such as ⅝ inch (15 mm) fire-resistant boards. Interior ½ inch panels (12 mm) benefit from extra strength obtained when a medium void structure is used, preferably having a narrow size distribution. The medium void structure is shown in FIG. 2. A large void structure has large voids that have a relatively narrow size distribution compared to the medium void structure and are relatively large in number compared to the small void structure. The large void structure is shown in FIG. 3. Structures of this type are not generally desired in gypsum panels.

A gypsum building panel is made using stucco and water to form a calcium sulfate dihydrate crystal matrix. Stucco is an inorganic binder material also known as calcined gypsum, calcium sulfate hemihydrate, calcium sulfate anhydrite or plaster of Paris. Synthetic gypsums, such as that formed as a by-product of flue gas desulfurization, are also useful. Any of the several forms of stucco are useful in the building panel of the present invention, including alpha or beta-calcined gypsum or mixtures thereof. A needle-shaped crystal of beta-stucco is formed by calcination at atmospheric pressure. Alpha-calcined stucco is produced when gypsum is calcined under pressure and is characterized by less acyclical crystals. Beta-calcined stucco requires more water than alpha-calcined stucco to make a slurry of equivalent flowability. Upon the addition of water, all forms of the stucco hydrate to form an interlocking matrix of calcium sulfate dihydrate crystals. Use of water in excess of that needed for hydration may result in loss of compressive strength due to increased size and number of interstitial voids in the crystal structure that held water between the time the gypsum set until it was fully dry. Usually, as the size and number of interstitial voids increases, the strength of the matrix decreases.

Addition of other inorganic binder components together with the stucco is contemplated for use with the present panel, including, but not limited to cement, pozzolans, gypsum and combinations thereof. In some embodiments the calcined gypsum is present in the slurry in amounts of more than 50% by weight of the total inorganic binder components. Water is added to the stucco in sufficient amounts to make a flowable slurry. The water to stucco ratio (“WSR”) is the weight of water per hundred weight dry stucco. A WSR of about 20 is the minimum amount of water needed to fully hydrate calcium sulfate hemihydrate. To maximize the product compressive strength, the WSR should be kept as low as practical. Some embodiments of the invention utilize a WSR from about 20 to about 100. Other embodiments have a WSR from about 40 to about 70. The amount of water required will depend on the type of calcined gypsum, the type and amount of additives used, the stucco source and the quantity of the additives that are utilized.

In addition to the stucco and water, the slurry utilized for some embodiments is made using two dispersants. Preferably the two dispersants include any dispersant and a polycondensation component. In some aspects of the invention, the dispersant is a dispersant component further described below. The slurry optionally includes additional components such as surfactants and antifoaming agents.

The dispersant component has one or more dispersant properties. Any dispersing properties known in the art are suitable. Examples of dispersing properties include, but are not limited to increased flowability, reduced particle size, slurry uniformity and reduction in water addition. The dispersant component is selected from a group that includes comb-branched polymers having polyether side chains, naphthalene sulfonate-formaldehyde condensates, melamine sulfonate-formaldehyde condensates and mixtures thereof. Preferably, from 0.05 to 1.0 wt. %, preferably from 0.1 to 0.5 wt. % and especially preferably from 0.15 to 0.3 wt. % of the additive blend is the dispersant component, each based on the total additive blend.

Formulations which contain a comb-branched polymer having polyether side chains as the dispersant component have been found to be effective. Examples of the dispersant component include a polycarboxylate ether, a polycarboxylate ester, an uncharged copolymer or a mixture thereof.

Polycarboxylate ether copolymers which are suitable as the dispersant component have been previously described in WO 2006/133933 A2, herein incorporated by reference. These copolymers consist of two repeating units. The first polycarboxylate repeating unit is derived from an olefinically unsaturated monocarboxylic acid comonomer, an ester or a salt thereof and/or an olefinically unsaturated sulfonic acid comonomer or a salt thereof.

The second polycarboxylate repeating unit is of the general formula (I)

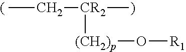

wherein R₁ represents

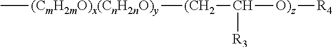

and R₂ represents H or an aliphatic hydrocarbon residue with 1 to 5 C atoms; R₃=unsubstituted or substituted aryl residue and preferably phenyl, and R₄=H or an aliphatic hydrocarbon residue with 1 to 20 C atoms, cycloaliphatic hydrocarbon residue with 5 to 8 C atoms, a substituted aryl residue with 6 to 14 C atoms or a member of the series:

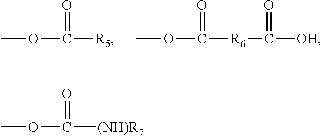

wherein R₅ and R₇ each represent an alkyl, aryl, aralkyl, or alkaryl residue and R₈ for an alkylidene, arylidene, aralkylidene or alkarylidene residue, and
p=0, 1, 2, 3 or 4
m, n mutually independently mean 2, 3, 4 or 5
x and y mutually independently denote an integer ≦350
and z=0 to 200.

In some embodiments, there are no internal molecular differences between the first polycarboxylate repeating unit and the second polycarboxylate repeating unit in polycarboxylate ether copolymer. Other embodiments of the copolymer utilize a polymeric mixture of the first polycarboxylate repeating unit and the second polycarboxylate repeating unit, in which case there are optionally internal molecular differences with respect to the radicals R¹, R², R³, R₄, R⁵, R⁶, R⁷, m, n, X, y and/or z. The differences often relate to the composition and length of the side chains.

The polycarboxylate ether copolymer includes the first polycarboxylate repeating unit in amounts of about 30 to about 99 mol. % and the second polycarboxylate repeating unit in amounts of about 70 to about 1 mol. %. Embodiments where the polycarboxylate ether copolymer includes the first polycarboxylate repeating unit in proportions of about 40 to about 90 mol. % and the second polycarboxylate repeating unit in amounts of about 60 to about 10 mol. % has been found particularly advantageous.

The first polycarboxylate repeating unit is preferably derived from an acrylic acid or a salt thereof and the second polycarboxylate repeating unit is derived from a monomer components that is preferably a vinyl or allyl group having as the residue R¹ a polyether and where p=0 or 1. Further, in some embodiments the first polycarboxylate repeating units derive from acrylic acid, methacrylic add, crotonic acid, isocrotonic acid, allylsulfonic acid, vinylsulfonic acid and suitable salts thereof and alkyl or hydroxyalkyl esters thereof.

In addition, the polycarboxylate ether copolymer optionally has additional structural groups in copolymerized form. In this case, the additional structural groups that include styrenes, acrylamides, hydrophobic compounds, ester repeating unit, polypropylene oxide and polypropylene oxide/polyethylene oxide units are preferred. The polycarboxylate ether copolymer includes the additional repeating units in amounts up to 5 mol. %, preferably from 0.05 to 3.0 mol. % and more preferably from 0.1 to 1.0 mol. %.

Any comb-branched polycarboxylate dispersant is useful in the slurry. Examples of useful polycarboxylate dispersants include, but are not limited to dispersants from the MELFLUX® Dispersant series by BASF Construction Polymers, GmbH (Tröstberg, Germany), ETHACRYL® M Dispersant by CoAtex, LLC (Chester, S.C.) and MIGHTY EG® Dispersant by Kao Corporation (XXX, XX). The use of combinations of dispersants is also contemplated. All of these polymers have polyoxyalkylene side chains. Suitable polycarboxylate esters are included in EP 0 753 488 B1, herein incorporated by reference. The polycarboxylate ester in some embodiments is prepared by polymerization of a monomer mixture containing a carboxylic acid monomer as the main component. In other embodiments, it is advantageous if the formula (I) represents a polyether containing alkyl or vinyl groups. An aspect of many polycarboxylate esters is their anti-foaming, defoaming and/or surface active properties. Therefore in some embodiments where the dispersant component is such a polycarboxylate ester, the dispersant component can provide antifoaming and surfactant effects in addition to their dispersing effect. In some embodiments, the monomer mixture includes an (alkoxy)polyalkylene glycol mono(meth)acrylate monomer of the general formula (II):

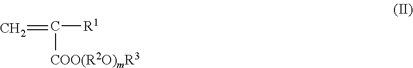

in which R¹ represents a hydrogen atom or a CH₃ group, R²O represents one representative or a mixture of at least two oxyalkylene groups having 2 to 4 carbon atoms, R³ represents a hydrogen atom or an alkyl group having 1 to 5 carbon atoms and m represents a number between 1 and 250 and represents the average number of moles of the oxyalkylene group added,
A second monomer is a (meth)acrylic acid of the general formula (III),

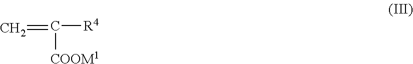

in which R⁴ represents a hydrogen atom or a CH₃ group and M¹ represents a hydrogen atom, a monovalent metal atom, a divalent metal atom, an ammonium group or an organic amine group.

An additional monomer is optionally copolymerized with the carboxylic acid monomers and the (meth)acrylic acid monomers. The carboxylic acid monomers are preferably present in an amount of from about 5 to about 98 wt. %, the (meth)acrylic acid monomers in an amount of from about 2 to about 95 wt. % and the optional monomer in an amount of up to about 50 wt. % in the monomer mixture (I).

Typical representatives of the polycarboxylate monomer include hydroxyethyl(meth)acrylate, hydroxypropyl(meth)acrylate, polyethylene glycol mono(meth)acrylate, polypropylene glycol mono(meth)acrylate, polybutylene glycol mono(meth)acrylate, polyethylene glycol polypropylene glycol mono(meth)acrylate, polyethylene glycol polybutylene glycol mono(meth)acrylate, polypropylene glycol polybutylene glycol mono(meth)acrylate, polyethylene glycol polypropylene glycol polybutylene glycol mono(meth)acrylate, methoxypolyethylene glycol mono(meth)acrylate, methoxypolypropylene glycol mono(meth)acrylate, methoxypolybutylene glycol mono(meth)acrylate, methoxypolyethylene glycol polypropylene glycol mono(meth)acrylate, methoxypolyethylene glycol polybutylene glycol mono(meth)acrylate, methoxypolypropylene glycol polybutylene glycol mono(meth)acrylate, methoxypolyethylene glycol polypropylene glycol polybutylene glycol mono(meth)acrylate, ethoxypolyethylene glycol mono(meth)acrylate, ethoxypolypropylene glycol mono(meth)acrylate, ethoxypolybutylene glycol mono(meth)acrylate, ethoxypolyethylene glycol polypropylene glycol mono(meth)acrylate, ethoxypolyethylene glycol polybutylene glycol mono(meth)acrylate, ethoxypolypropylene glycol polybutylene glycol mono(meth)acrylate, ethoxypolyethylene glycol polypropylene glycol polybutylene glycol mono(meth)acrylate or mixtures thereof.

For the (meth)acrylic acid monomer, acrylic acid, methacrylic acid, monovalent metal salts, divalent metal salts, ammonium salts and organic amine salts thereof and mixtures thereof are to be regarded as preferred.

As regards the additional optional monomer, it has an ester of an aliphatic alcohol with 1 to 20 carbon atoms and an unsaturated carboxylic acid. The unsaturated carboxylic acid is preferably maleic acid, fumaric acid, citraconic acid (meth)acrylic acid or monovalent metal salts, divalent metal salts, ammonium salts or organic amine salts thereof.

The polycarboxylate ester of the comb-branched polymer can be a copolymer which is made from at least one of the following monomers:

A) a first ethylenically unsaturated monomer containing a hydrolyzable residue;
B) a second ethylenically unsaturated monomer with at least one C₂-C₄ oxyalkylene side group with a chain length from 1 to 30 units; or
C) a third ethylenically unsaturated monomer with at least one C₂-C₄ oxyalkylene side group with a chain length from 31 to 350 units.

In a preferred embodiment of the present invention the second and third ethylenically unsaturated monomers are both present in the polycarboxylate ester.

The first ethylenically unsaturated monomer is at least one anhydride or imide and/or at least one maleic anhydride or maleimide. The first ethylenically unsaturated monomer also optionally includes an acrylate ester with an ester functionality which contains the hydrolyzable residue. In this case, it should be regarded as preferred if the ester functionality is at least one hydroxypropyl or hydroxyethyl radical.

In a further embodiment the polycarboxylate ester can further include more than one ethylenically unsaturated monomer with a hydrolyzable radical. Preferably the first ethylenically unsaturated monomer has more than one of the first ethylenically unsaturated monomers, at least one representative of a hydrolyzable radical or a mixture of both. In this case, the hydrolyzable radical should have at least one C₂-C₂₀ alcohol functionality. The present invention also includes the possibility that the hydrolyzable residue is at least one C₁-C₂ alkyl ester, one C₁-C₂₀ aminoalkyl ester, one C₂-C₂₀ alcohol, one C₂-C₂₀ amino alcohol or one amide.

At least one of the second or third ethylenically unsaturated monomer has a C₂-C₈ alkyl ether group. In this case, the ethylenically unsaturated monomer can have a vinyl, allyl or (methyl)allyl ether residue or else be derived from an unsaturated C₂-C₈ alcohol. In the latter case of the unsaturated C₂-C₈ alcohol, at least vinyl alcohol, (meth)allyl alcohol, isoprenol or methylbutenol are especially preferred possibilities as representatives. The ethylenically unsaturated monomer side groups of the second or third ethylenically unsaturated monomer can however also contain at least one C₄ oxyalkylene unit.

In connection with the modifications just described, concerning the polycarboxylate ester comb-branched polymer, it can be stated that at least one of the second and third ethylenically unsaturated monomers optionally has a C₂-C₈ carboxylate ester which in particular is hydrolyzable. Further, the oxyalkyl side groups have at least one ethylene oxide, one propylene oxide, one polyethylene oxide, one polypropylene oxide or mixtures thereof.

Finally, the polycarboxylate ester copolymer optionally includes at least one nonionic (“uncharged”) monomer, one non-hydrolyzable monomer residue or mixtures thereof.

In addition to the polycarboxylate ethers and polycarboxylate esters, the present invention also includes a fourth polycarboxylate repeating unit of the comb-branched polymer which is a nonionic copolymer. Units of the general formula (IV) are preferred for forming the nonionic copolymer.

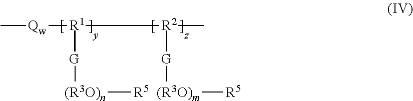

wherein Q stands for an ethylenically unsaturated monomer with at least one hydrolyzable residue, G means O, C(O)—O or O—(CH₂)ₚ—O with p=2 to 8, wherein mixtures of the modifications of G in one polymer are possible; R¹ and R², independently, are at least one C₂-C₈ alkyl; R³ comprises (CH₂)_{c} where c is a whole number between 2 and 5 and where mixtures of the representatives of R³ in the same polymer molecule are possible; R⁶ means at least one representative selected from the series H, a linear or branched, saturated or unsaturated C₁-C₂₀ aliphatic hydrocarbon residue, a C₅-C₈ cycloaliphatic hydrocarbon residue or a substituted or unsubstituted C₆-C₁₄ aryl residue; m=1 to 30, n=31 to 350, w=1 to 40, y=0 to 1 and z=0 to 1, where the sum (y+z)>0.

The nonionic copolymer alternatively includes units of the general Formula (V):

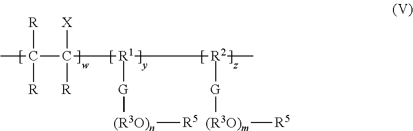

wherein X stands for a hydrolyzable residue and R for H or CH₃, and G, p, R¹, R², R³, R⁵, m, n, w, y, z and (y+z) have the meanings stated under the formula (IV).

In the case where the structure of the nonionic copolymer corresponds to Formula (V), in a preferred embodiment the hydrolyzable residue is at least one representative of the series alkyl ester, aminoalkyl ester, hydroxyalkyl ester, aminohydroxyalkyl ester or amide.

The nonionic copolymer can also be of the general formula (VI):

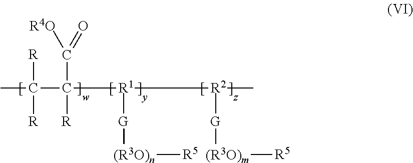

wherein R⁴ is at least one C₁-C₂₀ alkyl or a C₂-C₂₀ hydroxyalkyl radical, and the variables G, p, R, R¹, R², R³, c, R⁴, R⁵, m, n, w, y, z and (y+z) have the meanings as defined for the nonionic copolymer above.

It is preferable that in Formula (VI), p=4, R⁴=C₂H₄OH or C₃H₅OH, each of the radicals R⁵ represents H, m=5-30, n=31-250, w=1.5-30, y=0 to 1, z=0 to 1 and (y+z)>0. In another preferred embodiment, in Formulae (IV), (V) and (VI), the molar ratio of w to the sum (y+z) is 1:1 to 20:1 and preferably 2:1 to 12:1. Another preferred embodiment of Formula (VI) is a nonionic polyether-polyester copolymer.

The dispersant component acts to reduce the hydration speed, with some polycarboxylates causing severe set retardation. Most dispersants destabilize foam. An exception to this is a dispersant that includes an antifoaming component together with the dispersant.

Regardless of the specific dispersants or moieties that are selected, the dispersant component is optionally present in an additive blend in amounts of about 5% to about 95% by weight. In some embodiments the dispersant component is about 10% to about 60% or from about 15% to about 40% by weight of the additive blend.

Sulfonated condensates are also useful as the dispersant component. Sulfonic acid group containing s-triazines or naphthalene-formaldehyde condensates are broadly disclosed by prior art documents and frequently used as water reducing agents or plasticizers for cement based systems such as concrete.

β-naphthalene-sulfonate-formaldehyde condensates (“BNS”), also known as naphthalene-formaldehyde sulfonates, disperse particles by an electrostatic repulsion that results from adsorption processes. The molar ratio of formaldehyde to naphthalene sulfonic acid is from about 1.3 to 1 to about 3 to 1.

It is well known that commercially available flow improving agents based on melamine-formaldehyde-sulfonates, such as products of the MELMENT® series of dispersants from BASF Construction Polymers GmbH, Trostberg, Germany, cause an excellent liquefying effect even of low dosages of about 0.3 to 1.2 wt. %, relative to the weight of an inorganic binder.

The BNS or MFS dispersant is used in amounts of from 0.01 to 10 wt. % and preferably 0.1 to 5 wt. %, related to the hydraulic binder component. The molar ratio of the sulfonic group and related to the melamine component is of from 1.0 to 2.0 and the molar ratio of the formaldehyde related to the melamine component is from 2.5 to 5.0. Preferably the molar ratio melamine to sulfonic acid to formaldehyde is 1:1.1:1.5:3.3:3.6. Both BNS and MFS dispersants destabilize foam and increase fluidity in addition to increasing foam bubble structure.

The polycondensation component is also present in some embodiments. The polycondensation component is a copolymer having at least three polycondensate repeating units. A first polycondensate repeating unit has an aromatic or heteroaromatic sub-unit and a polyether side chain. A second polycondensate repeating unit includes at least one phosphated polycondensate repeating unit having an aromatic or heteroaromatic sub-unit. A third polycondensate repeating unit has an aromatic or heteroaromatic sub-unit. The second polycondensate repeating unit and the third polycondensate repeating unit differ exclusively in that the OP(OH)₂ group of the second polycondensate repeating unit is replaced by H in the third structural unit, and the third polycondensate repeating unit is not the same as the first polycondensate repeating unit.

The first polycondensate repeating unit of the polycondensation component is described by Formula (VII):

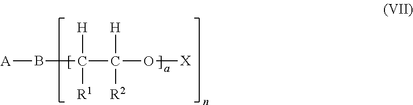

wherein A units are identical or different and are represented by a substituted or unsubstituted aromatic or heteroaromatic compound having 5 to 10 C atoms; where B units are identical or different and are represented by N, NH or O;
where n=2, if B=N and n=1, if B=NH or O;
wherein R¹ and R², independently of one another, are identical or different and are represented by a branched or straight-chain C₁- to C₁₀-alkyl radical, C₅- to C₈-cycloalkyl radical, aryl radical, heteroaryl radical or H;
wherein “a” values are identical or different and are represented by an integer from 1 to 300;
wherein X units are identical or different and are represented by a branched or straight-chain C₁- to C₁₀-alkyl radical, C₅- to C₈-cycloalkyl radical, aryl radical, heteroaryl radical or H.

The second polycondensate repeating unit is described by Formula (VIII):

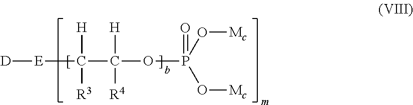

and the third polycondensate repeating unit is described by Formula (IX):

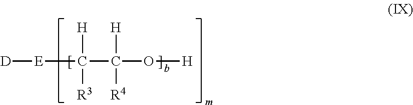

For Formulas (VIII) and (IX) in each case:

D units are identical or different and are represented by a substituted or unsubstituted heteroaromatic compound having 5 to 10 C atoms;
E units are identical or different and are represented by N, NH or O;
m—2 if E=N and m=1 if E=NH or O;
R³ and R⁴, independently of one another, are identical or different and are represented by a branched or straight-chain C₁- to C₁₀-alkyl radical, C₅- to C₆-cycloalkyl radical, aryl radical, heteroaryl radical or H;
“b” values are identical or different and are represented by an integer from 0 to 300;
M groups, independently of one another, are an alkaline metal ion, alkaline earth metal ion, ammonium ion, organic ammonium ion and/or H; and
c is 1 or in the case of alkaline earth metal ions ½.

In a preferred embodiment, the polycondensation component contains a fourth polycondensate repeating unit of Formula (X):

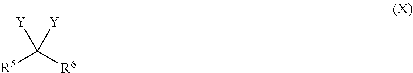

wherein Y groups, independently of one another, are identical or different and are represented by Formulae (VII), (VIII), (IX) or further constituents of the polycondensate; wherein R⁵ groups are identical or different and are represented by H, CH₃, COOM_{c} or a substituted or unsubstituted aromatic or heteroaromatic compound having 5 to 10 C atoms; and
wherein R₆ groups are identical or different and are represented by H, CH₃, COOM_{c} or a substituted or unsubstituted aromatic or heteroaromatic compound having 5 to 10 C atoms.

Preferably, R⁵ and R₆ in Formula (X), independently of one another, are represented by H, COOM_{c} and/or methyl.

The molar ratio of the units of Formulae (VII), (VIII), (IX) and (X) of the polycondensation component varies within wide ranges. In some embodiments wherein the molar ratio of the first, second, third and fourth polycondensate repeating units are represented by their formula number, then [(VII)+(VIII)+(IX)]:(X) is 1:0.8 to 3, preferably 1:0.9 to 2 and particularly preferably 1:0.95 to 1.2. The molar ratio of the first, second and third polycondensate repeating units (VII):[(VIII)+(IX)] in the polycondensation component is usually 1:15 to 15:1, preferably 1:10 to 10:1 and more preferably 1:5 to 3:1. In a preferred embodiment, the molar ratio of the second and third repeating units (VIII):(IX) is adjusted to 1:0.005 to 1:10, preferrably 1:0.01 to 1:1, in particular 1:0.01 to 1:0.2 and more preferably 1:0.01 to 1:0.1.

The groups A and D in the repeating units of Formulae (VII), (VIII) and (IX) of the polycondensation component are preferably represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl. It is possible for A and D to be chosen independently of one another and also in each case to consist of a mixture of said compounds. The groups B and E, independently of one another, are preferably represented by an oxygen atom, O.

The radicals R¹, R², R³ and R⁴ can be chosen independently of one another and are preferably represented by H, methyl, ethyl or phenyl, particularly preferably by H or methyl and especially preferably by H.

Value a in the first polycondensation repeating unit of Formula (VII) is preferably represented by an integer from 5 to 280, in particular 10 to 160 and particularly preferably 12 to 120. Value b in the second and third repeating units (VIII) and (IX) is an integer from 0 to 10, preferably 1 to 7 and particularly preferably 1 to 5. The respective radicals, the length of which is defined by a and b, respectively, may consist of uniform building blocks, but a mixture of different building blocks may also be expedient. Furthermore, the radicals of the first, second and third repeating units of Formulae (VII) or (VIII) and (IX), independently of one another, may each have the same chain length, a and b each being represented by a value. It is preferred that mixtures having different chain lengths are present in each case so that the radicals of the repeating units in the polycondensate have different numerical values for a and, independently, for b. Frequently, the phosphated polycondensate component has a weight average molecular weight of 4000 g/mol to 150 000 g/mol, preferably 10 000 to 100 000 g/mol and particularly preferably 20 000 to 75 000 g/mol.

Preferably, the phosphated polycondensation component is added to the slurry as an aqueous solution which contains about 2 to about 90% by weight of water and about 98 to about 10% by weight of dissolved dry matter, preferably about 40 to about 80% by weight of water and about 60 to about 20% by weight of dissolved dry matter, and more preferably about 45 to about 75% by weight of water and about 55 to about 25% by weight of dissolved dry matter. If desired other soluble, dry additives can also be dissolved in the same solution for convenient addition to the slurry, such as antifoaming agents.

In a particular embodiment, the invention furthermore contemplates a sodium, potassium, ammonium and/or calcium salt and preferably a sodium and calcium salt, of the phosphated polycondensation component.

A process for the phosphation of the polycondensation component is optionally carried out in the reaction mixture. This is to be understood as meaning that the phosphated polycondensation component formed in the reaction solution needs neither be purified nor isolated. The phosphation can be carried out before, during or after the polycondensation. Preferably both the phosphation and the polycondensation are carried out in the same reaction vessel.

In a preferred embodiment, the reaction mixture for synthesis of the polycondensation component includes at least a monomer of the first polycondensation repeating unit, a monomer of the third polycondensation repeating unit, and a further monomer having an aldehyde group and a phosphating agent. The monomer of the third polycondensation repeating unit is not the same as the monomer of the first polycondensation repeating unit. A portion of the monomer of the third polycondensation repeating unit is partially phosphated during the reaction and forms the monomer of the second polycondensation repeating unit as shown In Formula (VIIIa.) Each of the variables is defined in the same manner as for the corresponding polycondensation repeating unit above.

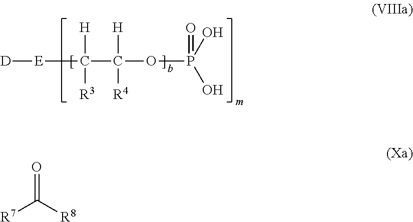

where R⁷ units are identical or different and are represented by H, CH₃, COOH and/or a substituted or unsubstituted aromatic or heteroaromatic compound having 5 to 10 C atoms; and where R⁸ units are identical or different and are represented by H, CH₃, COOH and/or a substituted or unsubstituted aromatic or heteroaromatic compound having 5 to 10 C atoms.

The present invention provides different variants of the reaction procedure. One possibility consists of first reacting the monomer of the third polycondensation repeating unit with a phosphating agent and subjecting the monomer of the second polycondensation repeating unit thus obtained to polycondensation with the monomers of the first and third polycondensation repeating units and the monomer of the fourth repeating unit. The monomer of the third polycondensation repeating unit may be present from an incomplete reaction during the phosphation reaction or can be deliberately added to the reaction mixture after the phosphation reaction.

However, it is also possible to subject the monomers of the first and third polycondensation repeating units and the further monomer to polycondensation and then to react the polycondensate product obtained with a phosphating agent. In another embodiment, the monomers of the first and third polycondensation repeating units, the monomer of the fourth repeating unit and the phosphating agent are reacted simultaneously. Polyphosphoric acid and/or phosphorous pentoxide are suitable phosphating agents. The polycondensation is carried out in the presence of an acidic catalyst, this preferably being sulfuric acid, methanesulfonic add, para-toluenesulfonic acid or mixtures thereof.

The polycondensation and the phosphation are advantageously carried out at a temperature between 20 and 140° C. and a pressure between 1 and 10 bar. In particular, a temperature range between 80 and 110° C. has proved to be useful. The duration of the reaction may be between 0.1 and 24 hours, depending on temperature, the chemical nature of the monomers used and the desired degree of crosslinking. Once the desired degree of crosslinking has been reached, which can also be determined, for example, by measurement of the viscosity of the reaction mixture, the reaction mixture is cooled.

According to a particular embodiment, the reaction mixture is subjected to a thermal aftertreatment at a pH between 8 and 13 and a temperature between 60 and 130° C. after the end of the condensation and phosphation reaction. As a result of the thermal aftertreatment, which advantageously lasts for between 5 minutes and 5 hours, it is possible substantially to reduce the aldehyde content, in particular the formaldehyde content, in the reaction solution.

In a further particular embodiment, the present invention envisages subjecting the reaction mixture to a vacuum aftertreatment at pressures between 10 and 900 mbar after the end of the condensation and phosphation reaction, for reducing the aldehyde content. Other methods known to the person skilled in the art for reducing the formaldehyde content may also be used. An example is the addition of small amounts of sodium bisulfite, ethylene urea or polyethylenimine.

The phosphated polycondensates obtained by these processes can be used directly as the polycondensation component. In order to obtain a better shelf life and better product properties, it is advantageous to treat the reaction solutions with basic compounds. Preferably the reaction mixture is treated after the end of the polycondensation reaction with a basic sodium, potassium, ammonium or calcium compound. Sodium hydroxide, potassium hydroxide, ammonium hydroxide or calcium hydroxide are particularly useful, since it is preferred to neutralize the reaction mixture. Other alkali metal and alkaline earth metal salts and salts of organic amine are suitable as salts of the phosphated polycondensate components.

Mixed salts of the phosphated polycondensation componentpoycondensation components are prepared by reacting the polycondensates with at least two basic compounds. Thus, by a targeted choice of suitable alkali metal and/or alkaline earth metal hydroxides, it is possible by neutralization to prepare salts of the polycondensation componentpolycondensation components, with which the duration of the processability of aqueous suspensions of inorganic binders and in particular of concrete can be influenced. While a reduction in the processability over time is observable in the case of the sodium salt, a complete reversal of this behavior takes place in the case of the calcium salt of the identical polymer, a smaller water reduction (smaller slump) occurring at the beginning and increasing with time. As a result of this, sodium salts of the phosphated polycondensation components lead to a decrease in the processability over time of the binder-containing material, such as, for example, concrete, mortar or gypsum slurries, whereas the corresponding calcium salts lead with time to improved processability. By suitable choice of the amount of sodium and calcium salts of the phosphated polycondensates used, the development of the processability of binder-containing materials can thus be controlled as a function of time. Expediently, the corresponding phosphated polycondensation components, which consist of sodium and calcium salts, are prepared by reaction with a mixture of basic calcium and sodium compounds, in particular calcium hydroxide and sodium hydroxide.

According to the present invention, a catalyst used can also be separated off. This can expediently be affected via the salt formed during the neutralization. If sulfuric acid is used as the catalyst and the reaction solution is treated with calcium hydroxide, the calcium sulfate formed can be separated off, for example, in a simple manner by filtration. Furthermore, by adjusting the pH of the reaction solution to 1.0 to 4.0, in particular 1.5 to 2.0, the phosphated polycondensation component is separated from the aqueous salt solution by phase separation and can be isolated. The phosphated polycondensation component can then be taken up in the desired amount of water. Other methods known to the person skilled in the art, such as dialysis, ultrafiltration or the use of an ion exchanger, are also suitable for separating off the catalyst.

Additionally, it is advantageous that the methods of making the phosphated polycondensation components can be prepared by a very economical process, with no further purification of intermediates being required. In particular, no wastes which have to be disposed of form in the process according to the invention. Thus, the claimed process also constitutes further progress compared with the prior art from environmental points of view. The reaction mixture obtained can be put directly to the intended formulation optionally after treatment with basic compounds.

In a specific embodiment the slurry includes the dispersant component, the polycondensation components, at least one antifoaming agent and/or a component having a surface-active effect, the antifoaming agent and component having a surface-active effect being structurally different from one another.

The antifoaming agent is preferably selected from the group consisting of a mineral oil, a vegetable oil, a silicon oil, a silicon containing emulsion, a fatty acid, a fatty acid ester, an organic modified polysiloxane, a borate ester, an alkoxylate, a polyoxyalkylene copolymer, ethylene oxide (EO)-propylene oxide (PO) block polymer, acetylenic diols having defoaming properties and a phosphoric ester having the formula P(O) (O—R⁸)₃₋ₓ(O—R⁹)ₓ where P represents phosphorus, O represents oxygen and R₈ and R⁹ are, independently, a C₂-C₂₀ alkyl or an aryl group and x=0, 1, 2, whereby an alkyl group with C₂-C₈ is preferred. Preferably the antifoaming agent includes tri-alkylphosphate and more preferably triiso-butylphosphate, a polyoxypropylene copolymer and a glycerol/alcohol acetate. Another embodiment of the slurry includes a mixture where the antifoaming agent includes a mixture of a tri-alkylphosphate and a polyoxypropylene copolymer.

The second optional component of the formulation, namely the surfactant, is preferably selected from the group consisting of a ethylene oxide/propylene oxide (EO/PO) block copolymer, a styrene/maleic add copolymer, a fatty alcohol alkoxylate, an alcohol ethoxylate R₁₀-(EO)-H with R₁₀ being an aliphatic hydrocarbon group having from 1 to 25 carbon atoms, acetylenic diols, monoalkylpolyalkylenes, ethoxylated nonylphenols, alkylsulfates, alkylethersulfats, alkylethersulfonates, alkyl ether carboxylates. More preferably the surfactant component includes an alcohol having a polyalkylene group of a carbon chain length of 2 to 20 carbon atoms, with a preferred carbon chain length of C₃-C₁₂.

Prior to addition to the gypsum slurry, the dispersant component and the polycondensation component are optionally pre-mixed in an aqueous composition that includes the antifoaming agent component in free form and/or attached to the dispersing component or the polycondensation component. If the antifoaming agent is attached to the dispersing component and/or the polycondensation component, it can be physically or chemically attached. The chemically attached antifoaming agent is preferably present in a polymerized or grafted form. When chemically attached, the antifoaming agent also can be considered as a third co-monomer of the copolymeric dispersing component. In its free form, the antifoaming agent is a blend component of the aqueous composition. Thus, antifoaming agent component is either physically or chemically attached to the dispersing component or it is a free form component. Any or all of these components can be added directly to the gypsum slurry without pre-blending.

In a further embodiment the antifoaming component is present in amounts of about 0.0002 to about 0.02% by weight and/or the surface-active component is present in amounts of about 0.0002 to about 0.02% by weight, based in each case on the total weight of the dispersants. According to a preferred embodiment the antifoaming formulation is characterized in that the antifoaming component or the surface-active component, independently of one another, are present in each case in an amount of about 0.01 to about 5% by weight, based in each case on the total weight of the formulation.

In another optional embodiment, in addition to the dispersing components, the polycondensation component and optionally the antifoaming agent or the surface-active component the slurry has at least one further compound. The further compound is preferably a polymer having a low charge, a neutral polymer or polyvinyl alcohol. This further compound and its role in systems containing calcium sulfate as hydraulic binder has been taught in the unpublished provisional European Patent application EP 08171022.0, herein incorporated by reference. The further compound is useful with gypsum compositions having certain day contents.

The total concentration of the dispersant component and polycondensation component to be included in the slurry ranges from 0.0002 to 1.6% by weight of the inorganic binder, or ranges from 0.001 to 1.0% by weight. In some embodiments, ranges from 0.002 to 0.4% by weight can be utilized. Other embodiments utilize 0.01 to 1.0% by weight or 0.05 to 0.2% by weight. The ratio of the dispersant component to the polycondensate component ranges from about 1:99 to about 99:1.

Additional additives are also added to the slurry as are typical for the particular application to which the gypsum slurry will be put. Amounts of retarder reported in pounds per 1000 ft² of board are based on a ½ inch (12 mm) gypsum panel.

Dry accelerators (up to about 35 lb./MSF (170 g/m2)) are added to modify the rate at which the hydration reactions take place. “CSA” is a set accelerator comprising 95% calcium sulfate dihydrate co-ground with 5% sugar and heated to 250° F. (121° C.) to caramelize the sugar. CSA is available from USG Corporation, Southard, Okla. plant, and is made according to U.S. Pat. No. 3,573,947, herein incorporated by reference. Potassium sulfate is another preferred accelerator. HRA is calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. Both of these are preferred accelerators. Set accelerators increase hydration speed but decrease fluidity.

Another accelerator, known as wet gypsum accelerator or WGA, is also a preferred accelerator. A description of the use of and a method for making wet gypsum accelerator are disclosed in U.S. Pat. No. 6,409,825, herein incorporated by reference. This accelerator includes at least one additive selected from the group consisting of an organic phosphonic compound, a phosphate-containing compound or mixtures thereof. This particular accelerator exhibits substantial longevity and maintains its effectiveness over time such that the wet gypsum accelerator can be made, stored, and even transported over long distances prior to use. The wet gypsum accelerator is used in amounts ranging from about 5 to about 80 pounds per thousand square feet (24.3 to 390 g/m²) of board product.

Set retarders (up to about 2 lb./MSF (9.8 g/m2)) are optionally used to prevent crystal formation in the mixer and to delay thickening of the gypsum slurry. The addition of the set retarder results in improved flowability of the slurry through the mixer because the thickening is delayed. Thus the amount of water in the slurry can be reduced. This water reduction effect is in addition to the water reduction effect provided by the dispersants. This effect is observed when retarder is used in amounts as little as 0.008% by weight based on the weight of dry calcined gypsum.

In some embodiments of the invention, additives are included in the gypsum slurry to modify one or more properties of the final product. Additives are used in the manner and amounts as are known in the art. Concentrations are reported in amounts per 1000 square feet of finished board panels (“MSF”). Reinforcing materials such as glass fibers are optionally added to the slurry in amounts of up to 11 lb./MSF (54 g/m²). Up to 15 lb./MSF (73.2 g/m²) of paper fibers are also added to the slurry. Wax emulsions are added to the gypsum slurry in amounts up to 90 lb./MSF (0.4 kg/m²) to improve the water-resistency of the finished gypsum board panel. Sugars, such as dextrose, are used to improve the paper bond at the ends of the boards. Polysiloxanes are used for water resistance. If stiffness is needed, boric acid is commonly added. Fire retardancy can be improved by the addition of vermiculite. These and other known additives are useful in the present slurry and wallboard formulations.

In embodiments of the invention that employ a foaming agent to yield foam voids in the set gypsum-containing product to provide lighter weight, any of the conventional foaming agents known to be useful in preparing foamed set gypsum products can be employed. Many such foaming agents are well known and readily available commercially, e.g. the HYONIC line of soap products from GEO Specialty Chemicals, Ambler, Pa. Any foaming agents are useful alone or in combination with other foaming agents. Generally, soaps do not affect hydration speed or fluidity directly. However, soap addition can reduce fluidity when small bubbles are produced that tightly pack together and resist flow.

An example of a combination includes a first foaming agent which forms a stable foam and a second foaming agent which forms an unstable foam. The first foaming agent is optionally a standard board soap with an alkyl chain length of 8-12 carbon atoms and an ethoxy group chain length of 1-4 units. The second foaming agent is optionally an unethoxylated soap with an alkyl chain length of 6-16 carbon atoms. Regulating the respective amounts of these two soaps allows for control of the panel foam void structure until 100% stable soap or 100% unstable soap is reached. Foams and a preferred method for preparing foamed gypsum products are disclosed in U.S. Pat. No. 5,643,510, herein incorporated by reference.

If foam is added to the product, the polycarboxylate dispersant is optionally divided between the gauging water and the foam water or two different dispersants are used in the gauging water and the foam water prior to its addition to the calcium sulfate hemihydrate. This method is disclosed in co-pending application U.S. Ser. No. 11/152,404, entitled, “Effective Use of Dispersants in Wallboard Containing Foam”, previously incorporated by reference.

A trimetaphosphate compound is added to the gypsum slurry in some embodiments to enhance the strength of the product and to improve sag resistance of the set gypsum. Preferably the concentration of the trimetaphosphate compound is from about 0.07% to about 2.0% based on the weight of the calcined gypsum. Gypsum compositions including trimetaphosphate compounds are disclosed in U.S. Pat. Nos. 6,342,284 and 6,632,550, both herein incorporated by reference. Exemplary trimetaphosphate salts include sodium, potassium or lithium salts of trimetaphosphate, such as those available from Astaris, LLC., St. Louis, Mo. Care must be exercised when using trimetaphosphate with lime or other modifiers that raise the pH of the slurry. Above a pH of about 9.5, the trimetaphosphate loses its ability to strengthen the product and the slurry becomes severely retardive.

Other potential additives to the wallboard are biocides to reduce growth of mold, mildew or fungi. Depending on the biocide selected and the intended use for the wallboard, the biocide can be added to the covering, the gypsum core or both. Examples of biocides include boric acid, pyrithione salts and copper salts. When used, biocides are used in the coverings in amounts of less than 500 ppm. Use of pryithione salts in gypsum panels are disclosed in U.S. Pat. No. 6,893,752, herein incorporated by reference. In addition, the gypsum composition optionally can include a starch, such as a pregelatinized starch or an acid-modified starch. The inclusion of the pregelatinized starch increases the strength of the set and dried gypsum cast and minimizes or avoids the risk of paper delamination under conditions of increased moisture (e.g., with regard to elevated ratios of water to calcined gypsum). One of ordinary skill in the art will appreciate methods of pregelatinizing raw starch, such as, for example, cooking raw starch in water at temperatures of at least about 185° F. (85° C.) or other methods. Suitable examples of pregelatinized starch include, but are not limited to, PCF 1000 starch, commercially available from Lauhoff Grain Company and AMERIKOR 818 and HQM PREGEL starches, both commercially available from Archer Daniels Midland Company. If included, the pregelatinized starch is present in any suitable amount. For example, if included, the pregelatinized starch can be added to the mixture used to form the set gypsum composition such that it is present in an amount of from about 0.5% to about 10% percent by weight of the set gypsum composition. Pregelatinized starches such as USG95 (United States Gypsum Company, Chicago, Ill.) are also optionally added for core strength.

In operation, the calcined gypsum is moved on a conveyor toward a mixer. Prior to entry into the mixer, dry additives, such as dry set accelerators, are added to the powdered calcined gypsum. Some additives are added directly to the mixer via a separate line. Trimetaphosphate is optionally added using this method. Other additives are optionally added directly to the mixing or gauging water. This is particularly convenient where the additives are supplied in liquid form. For most additives, there is no criticality regarding placing the additives in the slurry, and they may be added using whatever equipment or method is convenient. When using some polycarboxylate dispersants, it is important to add the dispersant to the water prior to addition of the stucco.

The ingredients are mixed in a high sheer mixer, such as a pin mixer, until a homogeneous slurry is obtained. Some panels have no foam added. In some embodiments, a foaming agent is added to the mixer and foam is generated in situ during mixing. In other embodiments, slurry is discharged into a chute where, optionally, pregenerated foam is added to the slurry. Foam is optionally added to the slurry by allowing it to flow over a foam ring having multiple foam outlets. This technique for foam addition is discussed in U.S. Pat. No. 5,683,635, herein incorporated by reference. After or during foam addition, the slurry travels down the chute where it is discharged as continuously onto a conveyor.

At or near the conveyor, a sample of the slurry is periodically taken to test the properties of the slurry and the set gypsum. A slump test is performed to determine the fluidity of the slurry. The temperature rise setting time is determined in accordance with CSA A82.2OM 1977 Physical Testing of Gypsum Plasters, Section 5.3, herein incorporated by reference. Since hydration of calcined gypsum is an exothermic reaction, the temperature rise in the slurry from the initial mixing temperature is indicative of the degree of set in the slurry.

Optionally, the conveyor is lined with a facing material onto which the slurry is deposited. Common facing materials include, but are not limited to paper or cardboard having one or multiple plies, fiberglass mats, scrims and plastic films. A second facing material optionally covers the slurry after it has been deposited to form a “sandwich” of the slurry between the two facing materials. The first facing material can be the same or different from the second facing material. Finished panels may include none, one or two facing materials. In some embodiments, a separate edge wrap material is placed on the edge facings of the panel between the slurry and the facing material. Where no facing material is used, the slurry is deposited directly onto the conveyor surface.

After the slurry and any optional facing materials are in place on the conveyor, it is formed into a panel. The term “panel” is intended to refer to a piece of material having a thickness that is smaller than either the length or the width. The slurry mass passes under a screed bar at a forming station to spread the slurry evenly over the surface, to flatten the slurry and to make a continuous gypsum ribbon of consistent thickness. Commonly, the screed bar is set to thicknesses of ½ (12 mm) or ⅝ (15 mm) of an inch, but thickness as small as ¼ inch (6 mm) are known and panel thickness can exceed one inch (25 mm) in thickness. Edge formers smooth the edge of the slurry mass and fold the edge of the facing material, when present, to cover the edge. When the ribbon has achieved a sufficient set strength, it is cut into lengths to form the panel. Preferably a surface of the panel is generally rectangular in shape. To speed drying of the panels, they are transferred into a kiln where they are dried at elevated temperatures.

At the knife where the panels are cut, a sample of the ribbon is taken periodically to determine the void structure of the set gypsum. The sample is cut or broken open to inspect the interior structure.

Based on the results of the production tests, adjustments are made in process parameters to improve the panel quality and/or manufacturing efficiency. If the hydration rate is not at the target value, changes in process variables such as, the amount of set accelerator, the amount of dispersant component or the amount of the polycondensate product component are useful. Fluidity of the slurry is affected by at least the amount of set accelerator, the amount of the polycondensate product component and the amount of the dispersant component. When correction in the foam structure is required, adjustments can be made to the amount of the dispersant component, the amount of the polycondensate product component, the amount of soap, the ratio of unstable to stable soap and the amount of antifoaming agents used in the slurry.

Adjusting the relative amounts of the dispersant component and the polycondensate component, or the relative amounts of any two dispersants, is useful in controlling one or more properties of the gypsum slurry or the resulting gypsum panel. A dispersant A and a dispersant B are preferably different dispersant types as a variety of repeating units are more likely to have different effects on the gypsum slurry. Examples of dispersant types that could be used include the dispersant component and the polycondensate component described herein, formaldehyde condensates such as BNS and MFS dispersants.

To be most effective, the dispersants should affect the efficacy, fluidity and bubble structure of the gypsum slurry differently. This is not to say that one dispersant need affect a given property in the opposite way as the other dispersant. One dispersant may have no effect on a property. However, the dispersants are selected to have effects of different magnitude with respect to the properties of interest. For example, some polycarboxylate ether dispersants strongly increase the fluidity of the slurry and tend to stabilize the bubbles. Naphthalene sulfonate dispersants increase fluidity to a lessor extent than the polycarboxylate but tend to destabilize the bubbles. These two dispersants would be suitable for use in this process. Two dispersants that would not be suitable for use together would be those that have the same effect on each property being considered. In this case, changing the ratio of the dispersants would not result in a change in the process conditions.

Dispersants having additional repeating units or pendant groups that act on properties of the slurry are also suitable. Particularly, dispersants are known to have antifoaming agents, surface-active groups or elements that assist the dispersant perform better in the presence of certain impurities, such as day contained in some stuccos.

Cases are also considered where either dispersant A, dispersant B or both are blends of dispersants. The dispersant component and the polycondensate component are available as a blend of these two dispersants. To obtain the ability to independently control the amount of the dispersant component relative to the polycondensate component, two different dispersant blends can be used. Here the dispersant blend A is made of the dispersant component and the polycondensate in a ratio of more than 1:1 on a weight basis. The dispersant blend B is prepared with the dispersant component and the polycondensate in a ratio of less than 1:1 on a weight basis.

Dispersant A and dispersant B are then combined in different amounts to change the ratio of the dispersant component to the polycondensate component. Dispersants A and B are optionally combined prior to addition to the gypsum slurry. During the manufacture of the gypsum boards, the relative amounts of dispersant A and dispersant B are varied to obtain the desired properties in response to the tests and observation of the slurry and panel product.

For example, consider a case where the dispersant component is a Melflux 2661 type PCE polymer and where the dispersant component and the polycondensate component both include an antifoaming component in this example, the target core structure is a medium void structure. If the slump test is high, indicating that the slurry is too fluid, the amount of dispersant A can be decreased to decrease the slump. However, decreasing the amount of dispersant A also decreases the hydration speed and decreases the foam stability. To maintain the foam stability, the amount of soap that produces unstable soap is decreased and the amount of soap that produces stable soap should be increased. Hydration speed can be adjusted by varying the amount of set accelerator.

In certain cases, it is not sufficient to vary only one of Dispersant A or Dispersant B. If in the previous example, the manufacturing facility were already running at 100% stable soap, it would not be possible to vary the soap ratio alone to maintain the same bubble size distribution as from before the amount of Dispersant A were increased. The total amount of soap that forms stable soap can be increased, however, the use of excessive amounts of soap causes problems in bonding of the gypsum panel to the facing material or the formation of blisters. Similarly, it is possible that the retardation may be too extreme that the continued addition of set accelerator may not be able to control the hydration speed. In cases such as these, it is beneficial also to independently vary the amount of the Dispersant B, and thus the ratio of the dispersant component to the polycondensate component. Dispersant B affects the fluidity almost as much as Dispersant A but has less of an effect on the foam void size and the hydration speed than Dispersant A. Changes that would need to be made in the slurry composition to compensate for the effects of dispersant changes are reduced. This technique is particularly helpful in cases where freedom to vary one of the other additives is limited. It should be noted that use of the technique is not limited to circumstances such as those discussed above. Varying the dispersant ratio should be considered any time it is necessary to make corrections in the slurry or product properties.

The following examples underline the advantages of the claimed slurry, its comprised components and its use.

### EXAMPLES

### 1. Preparation of Comb Branched Polycondensates

### Example 1.1

A reactor equipped with a stirrer and a heating mantle is filled with 580 parts of poly(ethyleneoxide)monophenylether (average molecular weight 5000 g/mol), 33.5 parts of concentrated sulfonic acid, 14 parts of water, 110 parts of ollgoethyleneglycolmonophenylether-phosphoric acid ester (average molecular weight 324 g/mol) and 64.1 parts of formaldehyde. This reaction mixture is stirred at 115° C. for 6 h. After cooling, 650 parts of water are added the reaction mixture is neutralized with 50% sodium hydroxide solution to a pH value of 6.5 to 7.

### Example 1.2

A reactor equipped with a stirrer and a heating mantle is filled with 600 parts of poly(ethyleneoxide)monophenylether (average molecular weight 5000 g/mol), 46 parts of concentrated methane sulfonic acid, 20 parts of water, 105 parts of phenoxyethanolphosphate and 13.2 parts of paraformaldehyde. This reaction mixture is stirred at 115° C. for 3.5 h. After cooling, 550 parts of water are added the reaction mixture is neutralized with 50% sodium hydroxide solution to a pH value of 6.5 to 7.

### Example 1.3

A reactor equipped with a stirrer and a heating mantle is filled with 400 parts of poly(ethyleneoxlde)monophenylether (average molecular weight 2000 g/mol), 34.3 parts of methane sulfonic acid (70%), 87.3 parts of 2-phenoxyethanolphosphate and 19.9 parts of parafomaldehyde. This reaction mixture is stirred at 115° C. for 2.5 h. After cooling, 450 parts of water are added the reaction mixture is neutralized with 50% sodium hydroxide solution to a pH value of 6.5 to 7.

### Example 1.4

A reactor equipped with a stirrer and a heating mantle is filled with 300 parts of poly(ethyleneoxide)monophenylether (average molecular weight 5000 g/mol), 280 parts of poly(ethyleneoxide)monophenylether (average molecular weight 2000 g/mol), 39.2 parts of conc. methane sulfonic acid, 17 parts of water, 152.7 parts 2-phenoxyethanolephosphate and 29.7 parts of paraformaldehyde. This reaction mixture is stirred at 120° C. for 3.5 h. After cooling, 550 parts of water are added the reaction mixture is neutralized with 50% sodium hydroxide solution to a pH value of 6.5 to 7.

### 2. Anwendungsbeispiele

The following dispersants have been used as comparison: the polycarboxylatether Melflux PCE 239 L/35% N.D. (PCE 239) and Melflux PCE 4930 L/42% (PCE 4930) and das Naphthalinsulfonate condensat Melcret 500 L (BNS), all of BASF Construction Polymers GmbH, Germany.

### Mortar Test

Flow Tests with Calciumsulfate-Semihydrate (Beta)

The needed quantity of the liquid dispersant according to Examples 1.1 to 1.4 has been stored in a reactor of a Hobart Mixer and the quantities of water according to the water/gypsum values of Tables 1 to 3 have been added. Then 400 g of a clay containing natural gypsum have been added together with an accelerator, it has been soaked for 15 sec and then mixed for 15 sec at 285 rpm (II). After 60 sec the flow has been determined with a cylinder (height 10 cm, diameter 5 cm). The hardening has been determined according to the knife cutting test.

The clay containing natural gypsum types A, B und C had the following mineralogic compositions: 86.6% Semi-hydrate, 0.9% Anhydrit, 1.5% Calcit, 4.6% Muskovit, 2.6% Chlorite (a 4 layered clay mineral); 3.8% other pollutants; 87.5% Semi-hydrate, 0.5% dihydrate, 5.9% Calcit, 3.4% Smektit (a 3 layered clay mineral), 2.7% other pollutants; and 78.9% semi-hydrate, 8.9% Dolomit, 1.6% Muskovit, 1.39% Quartz, 4.2% Chlorite (a 4 layered clay mineral), 5.01% other pollutants.

TABLE 1
Dispersing effect and retardation of the comparison examples and the
polycondensates of the invention in a clay containing natural gypsum A
(beta-semihydrate)

| | Dosage | Water- | | | |
|---|---|---|---|---|---|
| | [Weight- | Gypsum- | Accelerator | Flow | Setting Time |
| Example | %] | Value | [g] )* | [cm] | [min:s] |
| BNS | 0.460 | 0.67 | 0.220 | 20.2 | 2:15 |
| PCE 239 | 0.250 | 0.67 | 0.350 | 11.0 | 2:00 |
| EPPR 1 | 0.250 | 0.67 | 0.320 | 19.6 | 2:20 |

)* finely dispersed CaSO₄-Dihydrate

TABLE 2
Dispersing effect and retardation of the comparison examples and the
polycondensates of the invention in a clay containing natural gypsum B
(beta-Semihydrate)

| | Dosage | Water- | | | |
|---|---|---|---|---|---|
| | [Weight- | Gypsum- | Accelerator | Flow | Setting Time |
| Example | %] | Value | [g] )* | [cm] | [min:s] |
| BNS | 0.200 | 0.67 | 0.110 | 20.2 | 2:20 |
| PCE 4930 | 0.210 | 0.67 | 0.100 | 20.3 | 2:20 |
| EPPR 2 | 0.130 | 0.67 | 0.076 | 20.4 | 2:20 |
| BNS | 0.500 | 0.57 | 0.110 | 15.4 | 2:20 |
| PCE 4930 | 0.440 | 0.57 | 0.350 | 20.8 | 2:00 |
| EPPR 2 | 0.270 | 0.57 | 0.057 | 20.3 | 2:20 |

)* finely dispersed CaSO₄-Dihydrate

As can be seen from Tables 1 and 2 the polycondensates according to the invention have a significantly improved dispersing effect in clay containing gypsum compared to naphthalene sulfonates and the super PCE. Having an identical flow the polycondensates according to the invention induce a significantly reduction of the dosage quantity, preferably compared to to the also polyether based PCE. Additionally, the polycondensates according to the invention show no negative influence on the setting time of the gypsum.

TABLE 3
Dispersing effect and retardation of the comparison examples and the
polycondensates of the invention in a clay containing natural gypsum C
(beta-Semihydrate)

| | Dosage | Water- | | | |
|---|---|---|---|---|---|
| | [Weight- | Gypsum- | Accelerator | Flow | Setting Time |
| Example | %] | Value | [g] )* | [cm] | [min:s] |
| PCE 239 | 0.280 | 0.60 | | No flow | |
| EPPR 2 | 0.280 | 0.60 | 0.23 | 21.0 | 2:10 |
| EPPR 3 | 0.280 | 0.60 | 0.23 | 20.6 | 2:10 |
| EPPR 4 | 0.280 | 0.60 | 0.23 | 18.9 | 2:05 |

)* finely dispersed CaSO₄-Dihydrate

The results of Table 3 indicate a much increased dispersing effect of the polycondensates according to the invention on the high clay containing gypsum compared to the PCE. Additionally, the different structures of the polycondensates according to the invention show a good up to an optimum dispersing performance.

1. A gypsum slurry having comprising gypsum and a dispersant, wherein the dispersant is a polycondensation product comprising:
(I) a structural unit with an aromatic or heteroaromatic sub-unit and a polyether side chain;
(II) a phosphated structural unit with an aromatic or heteroaromatic sub-unit;
and optionally
(III) at least one structural unit with an aromatic or heteroaromatic sub-unit
wherein structural unit (II) and structural unit (III) differing exclusively in that the OP(OH)₂ group of the structural unit (II) is replaced by H in structural unit (III), and structural unit (III) is not the same as structural unit (I).

2. A gypsum slurry according to claim 1, wherein the structural unit (I) has the formula units 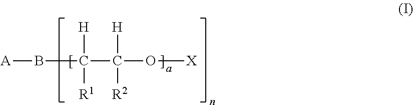
where wherein
A are identical or different and are represented by substituted or unsubstituted aromatic or heteroaromatic compound having 5 to 10 C atoms,
where
B are identical or different and are represented by N, NH or O
where
n=2, if B=N, and n=1, if B=NH or O
where wherein
R¹ and R² independently of one another, are identical or different and are represented by a branched or straight-chain C₁- to C₁₀-alkyl radical, C₅- to C₈-cycloalkyl radical, aryl radical, heteroaryl radical or H,
where wherein
a are identical or different and are an integer from 1 to 300,
wherein X
are identical or different and are represented by a branched or straight-chain C₁- to C₁₀-alkyl radical, C₅- to C₈-cycloalkyl radical, aryl radical, heteroaryl radical or H, wherein unit (II) has formula: 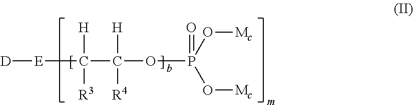
and unit (III) has formula: 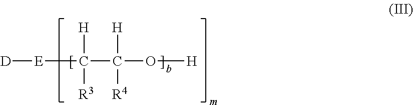
wherein
D are identical or different and are represented by a substituted or unsubstituted heteroaromatic compound having 5 to 10 C atoms,
where wherein
E are identical or different and are represented by N, NH or O
wherein
m=2, if E=N, and m=1, if E=NH or O
wherein
R³ and R⁴ are independently identical or different and are selected from the group consisting of: a branched or straight-chain C₁- to C₁₀-alkyl radical, C₅- to C₈-cycloalkyl radical, aryl radical, heteroaryl radical and H,
wherein b are identical or different and are an integer from 0 to 300, where wherein
M is independently of one another selected from the group consisting of an alkaline metal ion, alkaline earth metal ion, ammonium ion, organic ammonium ion and H, and wherein c is 1 or ½, wherein if M is an alkaline earth metal ion, c is ½.

3. A gypsum slurry according to claim 1, wherein the polycondensation product comprises a structural unit (IV) of formula 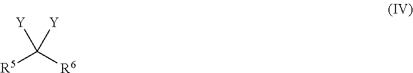
where wherein:
Y, independently of one another, are identical or different and are represented by unit (II), unit (III) or unit,
where wherein
are identical or different and are selected from the group consisting of H, CH₃, COOM_{c}, a substituted C₅₋₁₀ aromatic, unsubstituted C₅₋₁₀ aromatic a substituted C₅₋₁₀ heteroaromatic and an unsubstituted C₅₋₁₀ heteroaromatic where wherein
are identical or different and are selected from the group consisting of H, CH₃, COOM_{c}, a substituted C₅₋₁₀ aromatic, unsubstituted C₅₋₁₀ aromatic a substituted C₅₋₁₀ heteroaromatic and an unsubstituted C₅₋₁₀ heteroaromatic,
wherein
M is independently selected from the group consisting of an alkaline metal ion, alkaline earth metal ion, ammonium ion, organic ammonium ion and H, and
c is 1 or ½, wherein if Mc is an alkaline earth, c is ½.

4. A slurry according to claim 3, wherein R⁵ and R⁶ in structural unit (IV) of the polycondensation product are independently identical or different and are selected from the group consisting of H, COOM_{c} and methyl.

5. A slurry according to claim 1, wherein the molar ratio of the structural units [(I)+(II)+(II)+(III)]:(IV) in the polycondensation product is 1:0.8 to 3.

6. A slurry according to claim 1 to 5, wherein the molar ratio of the structural units (I):[(II)+(III)] is from 1:15 to 15:1.

7. A slurry according to claim 1, wherein the molar ratio of the structural units (II):(III) is from 1:0.005 to 1:10.

8. A slurry according to claim 1, wherein the polycondensation product is present in aqueous solution which contains 0.01 to 0.5 weight-%, based on the gypsum content.

9. A slurry according to claim 1, wherein it contains the polycondensation product as the sole compound with dispersing properties.

10. A slurry according to claim 1, wherein the polycondensation product is present in from 5 to 100% by weight, based in each case on the total formulation.

11. A slurry according to claim 10, wherein the formulation further comprises at least one member selected from the group consisting of antifoaming agent as component a) and a component b) having a surface-active effect, the components a) and b) being structurally different from one another.

12. A slurry according to claim 11, wherein the antifoam component a) is at least one member selected from the group consisting of mineral oil, vegetable oil, silicone oil, silicone-containing emulsions, fatty acid, fatty acid ester, organically modified polysiloxane, borate ester, alkoxylate, polyoxyalkylene copolymer, ethylene oxide propylene oxide block polymer, an acetylenic diol having antifoam and phosphoric acid ester of the formula P(O)(O—R₈)₃₋ₓ(O—R₉)ₓ in which P=phosphorus, O=oxygen and R₈ and R₉ are independently selected from the group consisting of a C₂₋₂₀-alkyl and an aryl group and wherein x=0, 1 or 2.

13. A slurry according to claim 12, wherein the antifoaming component a) is at least one representative of the series consisting of trialkyl phosphate, polyoxypropylene copolymer or glycerol/alcohol acetate.

14. A slurry according to claim 11, wherein the antifoaming component a) is triisobutyl phosphate.

15. A slurry according to claim 11, wherein the antifoam component a) represents a mixture of a trialkylphosphate and a polyoxypropylene copolymer.

16. A slurry according to claim 11, wherein the component b) is at least one representative selected from the group consisting of ethylene oxide/propylene oxide block copolymer, styrene/maleic acid copolymer, fatty acid alcohol alkoxylate, alcohol ethoxylate R₁₀-ethylene oxide-H wherein R₁₀ is an aliphatic hydrocarbon group having 1 to 25 carbon atoms, acetylenic diol, monoalkylpolyalkylene, ethoxylated nonylphenol, alkyl sulphate, alkyl ether sulphate, alkyl ether sulphonate and alkyl ether carboxylate.

17. A slurry according to claim 11, wherein the component b) comprises an alcohol having a polyalkylene group, and wherein the polyalkylene group has a carbon chain length of 2 to 20 carbon atoms.

18. A slurry according to claim 17, wherein the polyalkylene group has a carbon chain length of 3 to 12 carbon atoms.

19. A slurry according to claim 11, wherein the antifoaming component a) is in free form.

20. A slurry according to claim 11, wherein the antifoaming component a) is present in an amount of from 0.01 to 10% by weight or the surface-active component d) is present in an amount of from 0.01 to 10% by weight, based in each case on the total weight of the formulation.

21. A slurry according to claim 11, wherein the antifoaming component a) or the surface-active component b), independently of one another, are present in each case in an amount of from 0.01 to 5% by weight, based in each case on the total weight of the formulation.

22. A slurry according to claim 1, wherein it contains clay.

23. A slurry according to claim 1, wherein the gypsum component contains clay.

24. A slurry according to claim 22, wherein the clay is swellable and preferably water swellable and more preferably selected from the group Smectite, Montmorillionite, Bentonite, Vermiculite, Hectorite, or selected from the group Kaoline, Feldspar und Glimmer, or mixtures therefrom.

25. A slurry according to claim 22, wherein the clay is present in an amount of ≦20 weight-% based on the gypsum.

26. A slurry according to claim 1, wherein component c) is selected from the group consisting of a polymer having a low charge, a neutral polymer and a polyvinyl alcohol.

27. A slurry according to claim 26, wherein it contains the component c) in amounts of 1 to 50% by weight, preferably of 5 to 40% by weight and particularly preferably in amounts of 10 to 30% by weight, based in each case on the total weight of the formulation.

28. A slurry according to claim 26, wherein the polymer having a low charge is branched and the side chain preferably consists of a polyether or a polyester.

29. A slurry according to claim 26, wherein the polymer having a low charge is a polycarboxylate ether or a polycarboxylate ester, preferably having EO side chains or having a proportion of carboxylate of up to 83 mol %, preferably up to 75 mol %.

30. A slurry according to claim 26, wherein the polymer c) having a low charge comprises at least one monomer selected from the group consisting of polyether monoacrylate, polyether monomethacrylate, polyether monoallyl ether, polyether monomaleate, and monovinylated polyether.

31. A slurry according to claim 30, wherein the polyether is an alkylene oxide polymer having a molecular weight of 500 to 10,000.

32. A slurry according to claim 31, wherein the alkylene oxide is selected from the group consisting of ethylene oxide, propylene oxide, and butylene oxide.

33. A slurry according to claim 26, wherein the polymer c) having a low charge comprises at least one monomer selected from the group consisting of polypropylene glycol acrylate, polypropylene glycol methacrylates, polyethylene glycol acrylate, polyethylene glycol methacrylate, polypropylene glycol monovinyl ether, polyethylene glycol monovinyl ether, alkoxy- or aryloxypolyethylene glycol acrylate, alkoxy- or aryloxypolyethylene glycol methacrylates, alkoxy- or aryloxypolyethylene glycol monovinyl ether, acrylates, methacrylates and monovinyl ethers of an oxyalkylene or oxypropylene block or random copolymer, polypropylene glycol allyl ether, polyethylene glycol allyl ether, polyethylene glycol monomaleate and polypropylene glycol monomaleate.

34. A slurry according to claim 26, wherein the polymer c) having a low charge carries a carboxylic acid.

35. A slurry according to claim 26, wherein the polymer c) having a low charge carries a sulphonic acid group and is selected from the group consisting of 2-acrylamido-2-methylpropanesulphonic acid (AMPS), vinylsulphonic acid, allyl ether sulphonic acid, 2-sulphoethylmethacrylic acid, styrenesulphonic acid and methallylsulphonic acid, or their sodium, potassium and ammonium salts.

36. A slurry according to claim 26, wherein the neutral polymer c) comprises neutral monomer building blocks from the group consisting of an alkyl acrylate and an alkyl methacrylate having up to 5 carbon atoms.

37. A slurry according to claim 1, further comprising component d) a calcium-silicate-hydrate (C—S—H) containing composition.

38. A slurry according to claim 37, wherein the C—S—H has a calcium/silicium (Ca/Si)-molar ratio of 0.5 to 2.0.

39. A slurry according to claim 37, wherein the average particle size of C—S—H is smaller than 10 μm measured by light scattering with the equipment Master Sizer 2000 from the Malvern Company.

40. A slurry according to claim 37, wherein the average particle size of C—S—H is greater 0.01 μm.

41. A slurry according to claim 37, wherein the C—S—H containing composition is prepared by reacting a water-soluble calcium containing compound with a water-soluble silicate containing compound, wherein the reaction is carried out in the presence of an aqueous solution containing a water-soluble copolymer that is a dispersant for hydraulic binders and selected from at least a representative of component a) or b).

42. A slurry claim 37, wherein the C—S—H containing composition is prepareble by reaction of a calcium oxide, a calcium carbonate or a calcium hydroxide with a silicium dioxide during milling, wherein the reaction is carried out in the presence of an aqueous solution that contains a water-soluble copolymer that is a dispersant for hydraulic binders and is selected from the group consisting of a compound at least containing a branched comb polymer having polyether side chains, a naphthalene sulphonate-formaldehyde condensate and a melamine sulphonate-formaldehyde condensate.

43. A slurry according to claim 1, wherein the gypsum is selected from the group consisting of calcium sulphate, calcined gypsum, calcium sulfate hemihydrate, calcium sulfate anhydrite, plaster of Paris, and synthetic gypsums.

44. A building panel comprising the slurry of claim 1.

45. A building panel according to according to claim 44, wherein the building panel comprises:
a panel body comprising:
a calcium sulfate dihydrate matrix; and
a polycondensation component comprising:
ether:
a first polycondensation repeating unit having a polyether side chain and one of the group consisting of an aromatic sub-unit and a heteroaromatic sub-unit;
a second polycondensation repeating unit having a OP(OH)₂ group and one of the group consisting of an aromatic sub-unit and a heteroaromatic sub-unit; and
a third polycondensation repeating unit having one of the group consisting of an aromatic sub-unit and a heteroaromatic sub-unit;
wherein said second polycondensation repeating unit and said third polycondensation repeating unit differ exclusively in that the OP(OH)₂ groups of said second polycondensation repeating unit are replaced by H in said third polycondensation repeating unit, and said third polycondensation repeating unit is not the same as said first polycondensation repeating unit; and preferably additionally
a dispersant component selected from the group consisting of a comb-branched polymer having polyether side chains, naphthalene sulfonate-formaldehyde condensate, melamine sulfonate-formaldehyde condensate and mixtures thereof;
or:
a polycondensation product containing
(I) at least one structural unit with an aromatic or heteroaromatic sub-unit and a polyether side chain and
(II) at least one phosphated structural unit with an aromatic or heteroaromatic sub-unit,
and preferably additionally
(III) at least one structural unit with an aromatic or heteroaromatic sub-unit,
structural unit (II) and structural unit (III) differing exclusively in that the OP(OH)₂ group of the structural unit (II) is replaced by H in structural unit (III), and structural unit (III) is not the same as structural unit (I).

46. A building panel according to claim 45 wherein at least one member of the group consisting of said dispersant component and said polycondensation component comprises an antifoaming component.

47. A building panel according to claim 45 wherein said dispersant component is said comb-branched copolymer having polyether side chains and comprises:
at least one first polycarboxylate repeating unit derived from an olefinically unsaturated monocarboxylic acid comonomer or an ester or a salt thereof and an olefinically unsaturated sulfonic acid comonomer or a salt thereof, and
at least one second polycarboxylate repeating unit of formula (I) 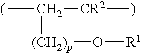
wherein R¹ is 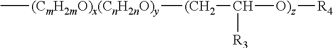
and R² is H or an aliphatic hydrocarbon radical having 1 to 5 C atoms; R³ is an unsubstituted or substituted aryl radical and R⁴ is H, an aliphatic hydrocarbon radical having 1 to 20 C atoms, a cycloaliphatic hydrocarbon radical having 5 to 8 C atoms, a substituted aryl radical having 6 to 14 C atoms, or one of the group consisting of: 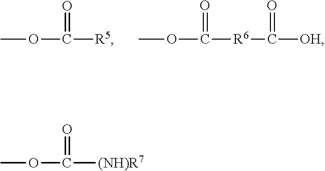
wherein R⁵ and R⁷ each represent an alkyl, aryl, aralkyl or alkaryl radical;
R⁶ represents an alkylidene, arylidene, aralkylidene or alkarylidene radical;
p=0, 1, 2, 3 or 4; m and n each, independently of one another, is 2, 3, 4 or 5;
x and y each, independently of one another, is an integer ≦350; and z is from 0 to about 200; and
wherein either the first and second polycarboxylate repeating units have no internal molecular differences or said first and second polycarboxylate repeating units have internal molecular differences with respect to at least one of said radicals R¹; R²; R³; R⁴; R⁵; R⁶; R⁷; m; n; x; y; and z, and the differences relate to the composition and length of side chains.

48. A building panel according to claim 45, wherein said first polycarboxylate repeating unit is present in amounts of 30 to 99 mol % and said second polycarboxylate repeating unit is present in amounts of about 70 to about 1 mol % of the dispersant component.

49. A building panel according to claim 45, wherein said first polycondensation repeating unit of the polycondensation component is of Formula VII: 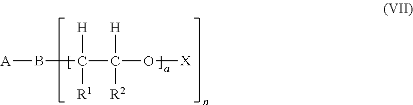
wherein A has 5 to 10 C atoms and is a substituted or unsubstituted aromatic or heteroaromatic compound; B is N, NH or O; n is 2 if B is N and n is 1 if B is NH or O; R¹ and R² each, independently of one another, is a branched or straight-chain C₁- to C₁₀-alkyl radical, C₅- to C₈-cycloalkyl radical, aryl radical, heteroaryl radical or H; a is an integer from about 1 to about 300, X is a branched or straight-chain C₁- to C₁₀-alkyl radical, C₅- to C₈-cycloalkyl radical, aryl radical, heteroaryl radical or H;
wherein said second polycondensate repeating unit of said polycondensation component is represented by Formula (VIII): 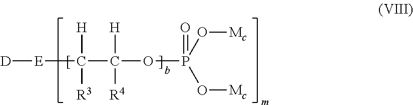
wherein said third polycondensate repeating unit of said polycondensation component is represented by Formula (IX): 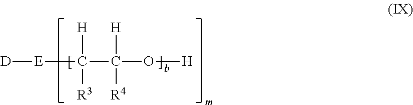
wherein in Formula (VIII) and Formula (IX) D is a substituted or unsubstituted heteroaromatic compound having 5 to 10 C atoms; E is N, NH or O; m is 2 if E is N and m is 1 if E is NH or O; R³ and R⁴ each, independently of one another, is a branched or straight-chain C₁- to C₁₀-alkyl radical, C₅- to C₈-cycloalkyl radical, aryl radical, heteroaryl radical or H; b is an integer from 0 to 300; M is an alkaline metal ion, alkaline earth metal ion, ammonium ion, organic ammonium ion or H, and c is ½ if M is an alkaline earth metal ion, or else c is 1; and wherein A, B, R¹, R², a, X, D, E, R³, R⁴, b, and M are each, independently of one another, identical or different among said individual first polycondensate repeating units.

50. A building panel according to claim 45 wherein said panel body is rectangular and from about 12 mm to about 25 mm in thickness.

51. A building panel according to claim 45 wherein said panel body further comprising one or more facing materials on one or more surfaces of said panel body.

52. A building panel according to claim 45 wherein the panel further comprising an additive selected from the group consisting of a set accelerator, a set retarder, an anti-sag agent, a bonding agent, a dedusting agent, a foaming agent, a reinforcing material, a biocide and combinations thereof.

53. A building panel according to claim 45 wherein said calcium sulfate dihydrate matrix comprises at least 50% by weight of all inorganic binder components in said panel body.

54. A building panel according to claim 45 wherein the panel further comprising a first foaming agent which forms stable foam and a second foaming agent which forms unstable foam.

55. A building panel according to claim 45 comprising:
combining calcium sulfate hemihydrate, water, the polycondensation component to form a slurry;
depositing the slurry onto a conveyor;
forming the slurry into a panel; and
allowing the calcium sulfate hemihydrate to hydrate and form a calcium sulfate dihydrate matrix.

56. A building panel according to claim 55 further comprising adding a foaming agent to the slurry.

57. A building panel according to claim 56 wherein the foaming agent is in the form of a foam.

58. A building panel according to claim 55 further comprising including an additive selected from the group consisting of a set accelerator, a set retarder, an anti-sag agent, a bonding agent, a dedusting agent, a foaming agent, a reinforcing material, a biocide and combinations thereof in the slurry.

59. A method of making a gypsum product comprising:
combining calcium sulfate hemihydrate, water and a first dosage of a first polycondensate dispersing compound;
if necessary adding a second dosage of a second dispersant;
testing properties of the gypsum slurry;
forming the slurry into a product;
allowing the product to set;
identifying properties of the product;
changing the first dosage of the first dispersant or the second dosage of the second dispersant to vary the ratio of the first dispersant to the second dispersant based on the properties of said identifying and said testing steps.

60. The method of claim 59 wherein the first dispersant comprises:
a first polycondensate repeating unit having a polyether side chain and one of the group consisting of an aromatic sub-unit and a heteroaromatic sub-unit;
a second polycondensate repeating unit having a OP(OH)₂ group and one of the group consisting of an aromatic sub-unit and a heteroaromatic sub-unit; and
a third polycondensate repeating unit having one of the group consisting of an aromatic sub-unit and a heteroaromatic sub-unit;
wherein the second polycondensate repeating unit and the third polycondensate repeating unit differ exclusively in that the OP(OH)₂ groups of the second polycondensate repeating unit is replaced by H in the third polycondensate repeating unit, and the third polycondensate repeating unit is not the same as the first polycondensate repeating unit.

61. The method of claim 59 wherein the second dispersant comprises: compositions having dispersing properties and being selected from the group consisting of a comb-branched polymer having polyether side chains, naphthalene sulphonate-formaldehyde condensate, melamine sulphonate-formaldehyde condensate and mixtures thereof.

62. The method of claim 59 further comprising incorporating a foaming agent into the gypsum slurry.

63. The method of claim 59 further comprising generating foam with the foaming agent and wherein the second dispersant of said adding step is added to the foam of said generating step.

64. The method of claim 59 wherein said combining step takes place in a mixer and wherein said combining step further comprises mixing one of the first dispersant, the second dispersant and combinations thereof with the water prior to entry into the mixer.

65. The method of claim 59 further comprising blending the gypsum slurry with a gypsum additive selected from the group consisting of a set retarder, a set accelerator, an anti-sag agent, a starch, a biocide, a bonding agent, a foaming agent, a reinforcing material, a dedusting agent and mixtures thereof.

66. The method of claim 59 wherein at least one of the first additive blend and the second additive blend further comprises an antifoaming component.
